(19) United States
(12) Patent Application Publication
(10) Pub. No.: US 2023/0157228 A1
(43) Pub. Date: May 25, 2023

(54) PROCESSES AND COMPOSITIONS FOR ENSILING HYDROPONICALLY GROWN CELLULOSIC MATERIALS

(71) Applicant: HydroGreen, Inc., LANGLEY (CA)

(72) Inventor: Shawn Jenkins, Colton, SD (US)

(73) Assignee: HydroGreen, Inc., LANGLEY (CA)

(21) Appl. No.: 17/534,137

(22) Filed: Nov. 23, 2021

(51) Int. Cl. A01G 31/00; C05F 11/02; A23K 30/18; A23K 10/30; A23K 10/14

(52) U.S. Cl. CPC A01G 31/00; C05F 11/02; A23K 30/18; A23K 10/30; A23K 10/14

(57) ABSTRACT

A system, method, and apparatus for ensiling hydroponically grown cellulosic material is disclosed. A grower system for growing plants and crops provides an aerobic environment by controlling a plurality of environmental factors that decrease environmental stresses surrounding the plants or crops. The decrease in environmental stresses increases hydrolytic enzyme activity and releases additional hydrolytic enzymes. The hydrolytic enzymes breakdown a plurality of complex storage molecules of the plant or crop into simple storage molecules. The breakdown of the plurality of complex storage molecules increases the nutrient availability and dry matter of the ensiled cellulosic material as well as the shelf life of the ensiled cellulosic material.

### FIELD OF THE INVENTION

The present disclosure relates to ensiling. More particularly, but not exclusively, the present disclosure relates to processes and compositions for ensiling hydroponically grown cellulosic materials.

### BACKGROUND

Livestock needs to consume a certain amount of dry matter and nutrients per day to maintain their health. Moldy silage results in higher dry matter losses or shrinkage and poor livestock performance. The spoilage or reduction in quality may be the result of aerobic conditions, improper ensiling preparation or packaging, or poor breakdown of plant material. During the silage process, different populations of bacteria utilize sugars enabling the ensiling process. The conversion of cellulosic material into more readily available forms, such as hemicellulose, increase the quality of the ensiled product Therefore, what is needed is a consistent, readily digestible, and elevated simple sugar product that provides advantages to the ensiling process by providing a greater energy source for lactic acid bacteria (LAB) thereby completing the ensiling process in a more efficient and timely manner. With a more efficient ensiling process, protein breakdown and losses would be expected to be minimized, thereby increasing shelf life and quality of the ensile material.

### SUMMARY

In one aspect of the present disclosure a method for ensiling hydroponically grown animal feed is disclosed. The method may include increasing the amount of gibberellic acid of a plurality of seeds on a seed bed of a grower system. The grower system may be configured to control a plurality of environmental factors. The method may also include releasing at least two types of enzymes within at least one seed of the plurality of seeds. The at least two types of the enzymes may be released by the increase in the amount of gibberellic acid. The method may further include breaking down a plurality of complex storage molecules into a plurality of simple molecules within the at least one seed by at least one enzyme of the at least two enzymes. The method may also include growing the at least one seed to maturity. Enzyme activity of the at least one seed may be maximized by the breakdown of the plurality of complex storage molecules. The method may include harvesting the plurality of seeds from the seed bed and ensiling the plurality of seeds. The enzyme activity may increase protein breakdown during an aerobic phase of the ensiling. The method may include providing an aerobic environment utilizing a grower system configured to control a plurality of environmental factors. The method may also include increasing oxygen supply to the plurality of seeds and irrigating the plurality of seeds with a liquid. The method may further include breaking down a plurality of complex storage molecules into a plurality of simple molecules within the plurality of seeds by hydrolysis. The method may also include producing adenosine triphosphate utilizing the plurality of simple sugars and growing the at least one seed into animal feed. The protein breakdown of the animal feed may be increased by the production of adenosine triphosphate. Lastly, the method may include ensiling the animal feed.

In another aspect of the present disclosure an ensiling system for ensiling hydroponically grown animal feed. The ensiling system may include a grower system and an ensiling apparatus. The grower system may further include a seed bed operably supported by a framework and disposed across a length and width of the framework having a first side opposing a second side and a first terminal end opposing a second terminal end. The seed bed may be configured to house a plurality of seeds and grow the seeds into maturity. The grower system may also include a control system for controlling a plurality of environmental factors of the seed bed. The plurality of environmental factors may provide an aerobic environment for growing the plurality of seeds. The aerobic environment may increase enzyme activity within the plurality of seeds. The grower system may also include a harvesting mechanism for removing the animal feed from the seed bed. The ensiling apparatus may be configured to ferment the plant and store the plant.

Therefore, it is a primary object, feature, or advantage of the present disclosure to improve over the state of the art.

It is a further object, feature, or advantage of the present disclosure to increase the shelf life of ensiled cellulosic material.

It is a still further object, feature, or advantage of the present disclosure to increase the quality of ensiled cellulosic material by growing at least some of the ensiled cellulosic material in a controlled environment.

Another object, feature, or advantage is to increase the dry matter in ensiled cellulosic material by increasing the enzyme activity within the cellulosic material.

Another object, feature, or advantage is to minimizing shrinkage of dry matter through a more efficient ensiling process.

Yet another object, feature, or advantage is to increase the nutrient availability in ensiled cellulosic material.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

### BRIEF DESCRIPTION OF THE DRAWINGS

Illustrated aspects of the disclosure are described in detail below with reference to the attached drawing figures, which are incorporated by reference herein.

FIG. 1 is an illustration of the interaction between phytohormones and dry matter in accordance with an illustrative aspect of the disclosure;

FIG. 2A is a pictorial representation of animal feed grown under hypoxic conditions;

FIG. 2B is a pictorial representation of animal feed grown under aerobic conditions;

FIG. 3 is chart illustrating adenosine triphosphate (ATP) production under different environmental conditions;

FIG. 4 is an illustration of the interaction between phytohormones in accordance with an illustrative aspect of the disclosure;

FIG. 5 is a flowchart illustrating reactive oxygen species (ROS) interaction with plant hormones in accordance with an illustrative aspect of the disclosure;

FIG. 6 is an illustration of the hydrolysis reaction of cellulose and xylan;

FIG. 7 is an illustration depicting the hydrolysis of maltose into two glucose molecules.

FIG. 8 is an illustration depicting Adenosine Triphosphate production;

FIG. 9 is a chart illustrating the germination percentage of barley over different hydrogen peroxide concentrations and salinity treatments in accordance with an illustrative aspect of the disclosure;

FIG. 10 is a chart of the digestible neutral detergent fiber fractions expressed as a percentage over three mix collection timepoints;

FIG. 11 is a chart illustrating estimated total digestible nutrient percentage over four mix collection timepoints;

FIG. 12 is a chart illustrating starch digestion expressed as a percentage over three mix collection timepoints;

FIG. 13 is a chart illustrating digestible neutral detergent fiber fractions expressed as a percentage over four mix collection timepoints;

FIG. 14 is an illustration of the ensiling system in accordance with one aspect of the present disclosure;

FIG. 15 is an illustration of the grower system in accordance with an illustrative aspect of the disclosure;

FIG. 16 is a side perspective view of a portion of the seed bed of the growing system in accordance with an illustrative aspect of the disclosure;

FIG. 17 is another side perspective view of a portion of the grower system illustrating a seed bed thereof;

FIG. 18 is a side perspective view of a portion of the grower system illustrating another seed bed thereof;

FIG. 19 is an end perspective view of a portion of the grower system further illustrating the seed bed shown in FIG. 18;

FIG. 20 is a side perspective view of a portion of the grower system illustrating another seed bed thereof;

FIG. 21 is a top view of a harvesting mechanism in accordance with an illustrative aspect of the disclosure;

FIG. 22 is a block diagram illustrating another perspective of the grower system;

FIG. 23 is a flowchart illustrating a method for ensiling hydroponically grown seeds; and

FIG. 24 is another flowchart illustrating a method for ensiling hydroponically grown seeds.

### DETAILED DESCRIPTION

This disclosure relates to the use of an oxygen rich environment produced during controlled hydroponic germination of seeds for increasing dry matter and nutrients in animal feedstuffs and cellulosic material including feed concentrates, forages, and mineral supplements. Leveraging metabolic processes common to higher plants during germination and seedling development and plant's environment, the grower system enables the transformation of complex polysaccharides including starch and cellulose, complex proteins, and triglycerides into their reduced monosaccharide, amino acid, and fatty acid precursors, respectively. Therefore, a consistent, readily digestible, and elevated simple sugar product that provides advantages to the ensiling process by providing greater a greater energy source for LAB completes the ensiling process in a more efficient and timely manner. With a more efficient ensiling process, protein breakdown and losses would be expected to be minimized, thereby increasing shelf life and quality of the ensile material with readily available nutrient sources. The reduction in harmful bacterial limits the loss of dry matter and nutrients and increases the shelf life of the ensiled material.

The plant or seed may refer to any plant from the kingdom Plantae or angiosperms including flowering plants, cereal grains, grain legumes, grasses, roots and tuber crops, vegetable crops, fruit plants, pulses, medicinal crops, aromatic crops, beverage plants, sugars and starches, spices, oil plants, fiber crops, latex crops, food crops, feed crops, plantation crops or forage crops.

Cereal grains may include rice (Oryza sativa), wheat (Triticum), maize (Zea mays), rye (Secale cereale), oat (Avena sativa), barley, (Hordeum vulgare), sorghum (Sorghum bicolor), pearl millet (Pennisetum glacucum), finger millet (Eleusine coracana), barnyard millet (Echinochloa frumentacea), Italian millet (Setaria italica), kodo millet (Paspalum scrobiculatum), common millet (Panicum millaceum).

Pulses may include black gram, kalai, or urd (Vigna mungo var, radiatus), chickling vetch (Lathyrus sativus), chickpea (Cicer arietinum), cowpea (Vigna sinensis), green gram mung (Vigna radiatus), horse gram (Macrotyloma uniflorum), lentil (Lens esculenta), moth bean (Phaseolus aconitifolia), peas (Pisum sativum) pigeon pea (Cajanas cajan, Cajanus indicus), philipesara (Phaseolus trilobus), soybean (Glycine max).

Oilseeds may include black mustard (Brassica nigra), castor (Ricinus communis), coconut (Cocus nucifera), peanut (Arachis hypgaea), Indian mustard (Brassica juncea), toria (Napus), niger (Guizotia abyssinica), linseed (Linum usitatissumun), safflower (Carthamus tinctorious), sesame (Seasmum indicum), sunflower (Helianthus annus), white mustard (Brassica alba), oil palm (Elaeis guniensis). Fiber crops may include sun hemp (Crotalaria juncea), jute (Corchorus), cotton (Gossypium), mesta (Hibiscus), or tobacco (Nicotiana).

Sugar and starch crops may include potato (Solanum tberosum), sweet potato (Ipomea batatus), tapioca (Manihunt esculenta), sugarcane (Saccharum officinarum), sugar beet (Beta vulgaris). Spices may include black pepper (Piper nigrum) betel vine (Piper betle), cardamom (Elettaria cardamomum), garlic (Allium sativum), ginger (Zingiber officinale), onion (Allium cepa), red pepper or chillies (Capsicum annum), or turmeric (Curcuma longa). Forage grasses may include buffel grass or anjan (Cenchrus ciliaris), dallis grass (Paspalum dilatatum), dinanath grass (Pennisetum), guniea grass (Panicum maximum), marvel grass (Dicanthium annulatum), napier or elephant grass (Pennisetum purpureum), pangola grass (Digitaria decumbens), para grass (Brachiaria mutica), sudan grass (Sorghum sudanense), teosinte (Echlaena mexicana), or blue panicum (Panicum antidotale). Forage legume crops may include berseem or Egyptian clover (Trifolium alexandrinum), centrosema (Centrosema pubescens), gaur or cluster bean (Cyamopsis tetragonoloba), Alfalfa or lucerne (Medicago sativa), sirato (Macroptlium atropurpureum), velvet bean (Mucuna cochinchinensis).

Plantation crops may include banana (Musa paradisiaca), areca palm (Areca catechu), arrowroot (Maranta arundinacea), cacao (Theobroma cacao), coconut (Cocos nucifera), Coffee (Coffea arabica), tea (Camellia theasinesis). Vegetable crops may include ash gourd (Beniacasa cerifera), bitter gourd (Momordica charantia), bottle gourd (Lagenaria leucantha), brinjal (Solanum melongena), broad bean (Vicia faba), cabbage (Brassica), carrot (Daucus carota), cauliflower (Brassica), colocasia (Colocasia esulenta), cucumber (Cucumis sativus), double bean (Phaseolus lunatus), elephant ear or edible arum (Colocasia antiquorum), elephant foot or yam (Amorphophallus campanulatus), french bean (Phaseolus vlugaris), knol khol (Brassica), yam (Dioscorea) lettuce (Lactuca sativa), must melon (Cucumis melo), pointed gourd or parwal (Trchosanthes diora), pumpkin (Cucrbita), radish (Raphanus sativus), bhendi (Abelmoschus esculentus), ridge gourd (Luffa acutangular), spinach (Spinacia oleracea), snake gourd (Trichosanthes anguina), tomato (Lycoperscium esculentus), turnip (Brassica), or watermelon (Citrullus vulgaris).

Medicinal crops may include aloe (Aloe vera), ashwagnatha (Withania somnifera), belladonna (Atropa belladonna), bishop's weed (Ammi visnaga), bringaraj (Eclipta alba.), cinchona (Cinchona sp.) coleus (Coleus forskholli), dioscorea, (Dioscorea), glory lily (Gloriosa superba), ipecae (Cephaelis ipecauanha), long pepper (Poper longum), prim rose (Oenothera lamarekiana), roselle (Hibiscus sabdariffa), sarpagandha (Rauvalfia serpentine) senna (Cassia angustifolia), sweet flag (Acorus calamus), or valeriana (Valeriana wallaichii).

Aromatic crops may include ambrette (Abelmoschus moschatus), celery (Apium graveolens), citronella (Cymbopogon winterianus), geranium (Pelargonium graveolens.), Jasmine (Jasminum grantiflorum), khus (Vetiveria zizanoids), lavender (Lavendula sp.) lemon grass (Cymbopogon flexuosus), mint, palmarosa (Cymbopogon martini), patchouli (Pogostemon cablin), sandal wood (Santalum album), sacred basil (Ocimum sanctum), or Tuberose (Polianthus tuberosa). Food crops are harvested for human consumption and feed crops are harvested for livestock consumption. Forage crops may include crops that animals feed on directly or that may be cut and fed to livestock.

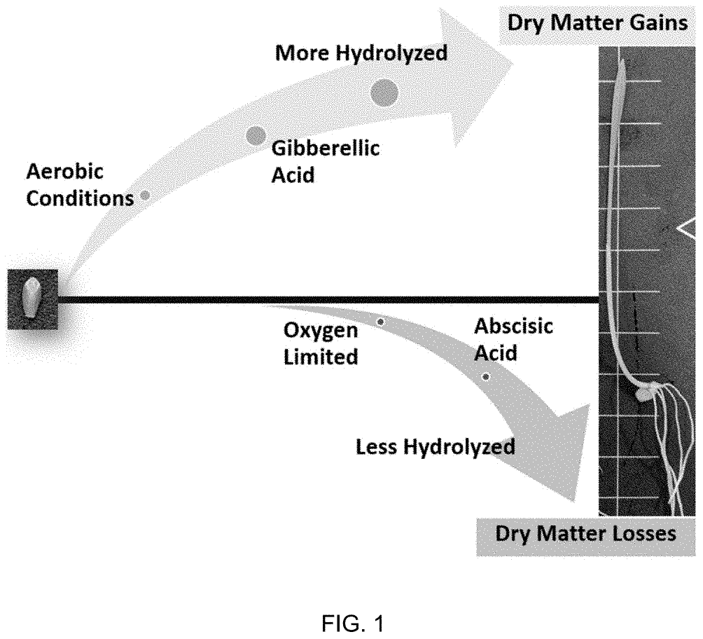

Dry matter is the part of animal feed or crop that remains after its water content is removed. Dry matter includes carbohydrates, fats, proteins, vitamins, minerals, nutrients, or antioxidants. Livestock needs to consume a certain amount of dry matter per day to maintain their health. Fresh pastures have a high-water content and a lower percentage of dry matter. What is needed is a process, apparatus, and system for increasing dry matter in animal feed, forage crops, or food crops. Plant growth and the amount of dry matter are greatly affected by the environment. Most plant problems such as decreased dry matter are caused by environmental stress. Environmental factors such as water, humidity, nutrition, light, temperature, and/or level of oxygen present can affect a plant's growth and development as shown in FIGS. 1-3.

Nutrient digestibility is the amount of nutrients absorbed by the individual or animal and is generally calculated as the amount of nutrients consumed minus the amount of nutrients retained in the feces. The incorporation of enzymes into dairy and beef rations has yielded mixed results and has primarily been focused on amylase in cattle. The incorporation of amylase into dairy and beef rations has been shown to increase milk to feed conversions by twelve percent when 15,000 KNUs were supplied in a starch rich ration (Gencoglu et al., 2011). In beef cattle, the addition of 12,000 KNUs of exogenouse amylase improved the daily rate of gain by eight percent % (Tricarico et al., 2007). The direct influence of amylase of milk yield and components it is mixed with increases in milk and milk components reported by few authors (Klingerman et al., 2009). Consistently across trials, the addition of amylase has been reported to improve nutrient digestibility and feed use efficiency (Gencoglu et al, 2011; Tricarico et al., 2007; Klingerman et al., 2009; Andreazzi et al., 2018; Noziere et al., 2014; Meschiatti et al., 2019). In general, experiments where the enzyme is incorporated into a high starch diet and allowed time to act before animal digestion appear to trend higher in overall impact (Tricarico et al., 2007; Klingerman et al., 2009). The use of enzymes produced during the germination process of cereal grains has long been used in application for the malting industry, the process of leveraging enzymes produced during the optimized hydroponic germination of seeds has yet to be implemented in the feed industry to improve the digestion of feedstuffs. By leveraging enzymes, and providing a plant with the right conditions, the plant's dry matter increases and the enzymes are able to begin the ensiling process without additives or with limited additives.

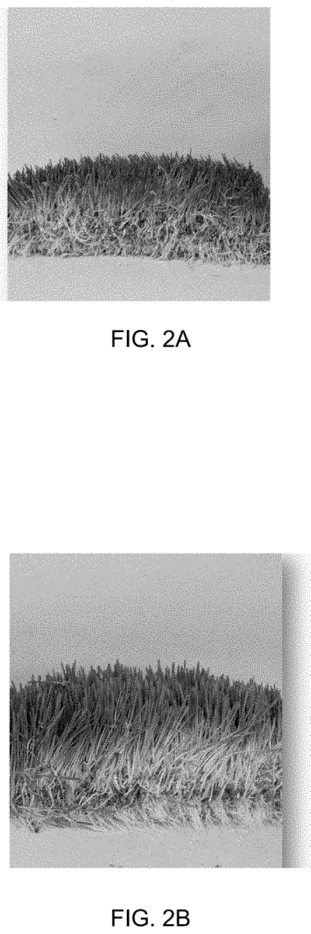

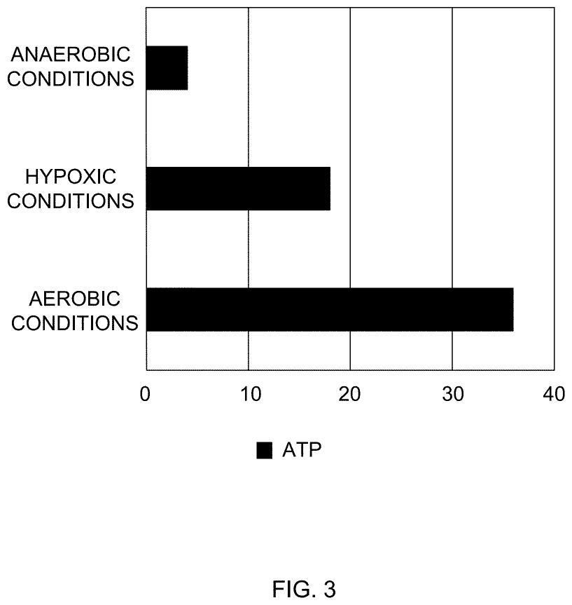

Oxygen is a necessary component in many plant processes included respiration and nutrient movement from the soil into the roots. The amount of oxygen can influence the efficiency of respiration. Oxygen moves passively into the plant through diffusion. In plants growing in anaerobic conditions, the uptake or disappearance of oxygen is greater than or diffusion by physical transport from the surrounding environment can prevent or decrease the likelihood of germination and early seedling development. Anaerobic conditions can cause nutrient deficiencies or toxicities within the plant, root or plant death, reduced growth of the plant, or reduced dry matter. Oxygen is not available as an electron acceptor in glycolysis or oxidative phosphorylation. Anaerobic conditions may be caused by a decrease in the amount of oxygen in the air, such as growing a plant or seed in a room without air or oxygen circulation. However, oxygen bound in compounds such as nitrate (NO₃), nitrite (NO₂), and sulfites (SO₃) may still be present in the environment. Waterlogging, where excess water in the root zone of the plant or in the soil which inhibits gaseous exchange with the air, can also cause anaerobic conditions. Hypoxic conditions arise when there is insufficient oxygen in a plant's environment and the plant must adapt its growth and metabolism accordingly. Excessive watering or waterlogged soil can cause hypoxic conditions. When anaerobic or hypoxic conditions persist, the microbial, fungal, and plant activities quickly use up any remaining oxygen. The plant becomes stressed due to the lack of nutrient uptake by the roots, the plant stomata begin to close, photosynthesis is reduced and dry matter decreases. A prolonged period of oxygen deficiency can lead to reduced yields, root dieback, plant death, or greater susceptibility to disease and pests as shown in FIG. 2A. Under aerobic conditions, plant growth can thrive, as shown in FIG. 2B. Aerobic conditions are when there are enough oxygen molecules or compounds and energy present to carry out oxidative reactions, increase the plant's metabolism and increase dry matter, as shown in FIG. 3.

Light is a necessary component for plant growth and the increase in the production of enzymes, sugars and starches that increase dry matter. The more light a plant receives, the greater its capacity for producing food and energy via photosynthesis and other plant mechanisms to increase enzyme availability. The enzymes facilitate hydrolysis to increase or create dry matter through the conversion of chemical energy stored in water to metabolically available forms, such as hydroxide or hydrogen affixed to monomer units of the nutrients. Light can facilitate early germination and early seedling development thereby increasing the availability of enzymes. The energy can be used to produce or increase the expression of enzymes that increase dry matter and enzyme activity. Temperature influences most plant processes, including photosynthesis, transpiration, respiration, germination, and flowering. As temperature increases up to a certain point, photosynthesis, transpiration, and respiration increase. When the temperature is too low or exceeds the maximum point photosynthesis, transpiration, and respiration decrease. When combined with day-length, temperature also affects the change from vegetative to reproductive growth. The temperature for germination may vary by plant species. Generally, cool-season crops (e.g., spinach, radish, and lettuce) germinate between 55° to 65° F., while warm-season crops (e.g., tomato, petunia, and lobelia) germinate between at 65° to 75° F. Low temperatures reduce energy use and increase simple sugar storage whereas adverse temperatures, however, cause stunted growth and poor-quality plants. The specific control of temperature encourages maximum enzyme hydrolysis throughout development while potentially discouraging the cellular division near the onset of photosynthesis thereby increasing dry matter and enzyme activity. Temperatures near the cardinal range of seeds is believed to support maximum enzyme hydrolysis approximately through the first 120 hours. Reducing temperatures below the cardinal value at 120 hours is believed to reduce metabolic activity in tissue readily exposed to the environment while having reduced influence on the seed within the cellulosic material layer decreasing dry matter and enzyme activity.

Water and humidity play an important role in increasing dry matter and leveraging enzyme activity. Most growing plants contain ninety percent water, Water is the primary component of photosynthesis and respiration. Water is also responsible for the turgor pressure needed to maintain cell shape and ensure cell growth. Water acts as a solvent for minerals and carbohydrates moving through the plant, acts as a medium for some plant biochemical reactions, increases enzyme production and expression, and cools the plant as it evaporates during transpiration. Water can regulate stomatal opening and closing thereby controlling transpiration and photosynthesis and is a source of pressure for moving roots through a growing medium such as soil. Humidity is the ratio of water vapor in the air to the amount of water the air can hold at the current temperature and pressure. Warm air can hold more water vapor than cold air. Water vapor moves from an area of high humidity to an area of low humidity. Water vapor moves faster if there is a greater difference between the area of high humidity and the area of low humidity. When the plant's stoma open, a plant's water vapor rushes outside the plant into the surrounding air. An area of high humidity forms around the stoma and reduces the difference in humidity between the air spaces inside the plant and the air adjacent to the plant, slowing down transpiration. If air blows the area of high humidity around the plant away, transpiration increases.

Plant nutrition plays an important role in increasing dry matter and leveraging enzymes. Plant nutrition is the plant's need for and use of basic chemical elements. Plants need at least 17 chemical elements for normal growth. Carbon, hydrogen, and oxygen can be found in the air or in water. The macronutrients, nitrogen, potassium, magnesium, calcium, phosphorus, and sulfur are used in relatively large amounts by plants. Nitrogen plays a fundamental role in energy metabolism, protein synthesis, and is directly related to plant growth. It is indispensable for photosynthesis activity and chlorophyll formation. It promotes cellular multiplication. A nitrogen deficiency results in a loss of vigor and color. Growth becomes slow and leaves fall off, starting at the bottom of the plant. Calcium attaches to the walls of plant tissues, stabilizing the cell wall and favoring cell wall formation. Calcium aids in cell growth, cell development and improves plant vigor by activating the formation of roots and their growth. Calcium stabilizes and regulates several different processes. Magnesium is essential for photosynthesis and promotes the absorption and transportation of phosphorus. It contributes to the storage of sugars within the plant. Magnesium performs the function of an enzyme activator. Sulfur is necessary for performing photosynthesis and intervenes in protein synthesis and tissue formation.

The plant micronutrients or trace elements, iron, zinc, molybdenum, manganese, boron, copper, cobalt, and chlorine, are used by the plant in smaller amounts. Macronutrients and micronutrients can be dissolved by water and then absorbed by a plant's roots. A shortage in any of them leads to deficiencies, with different adverse effects on the plant's general state, depending upon which nutrient is missing and to what degree. Fertilization may affect dry matter and enzyme activity. Fertilization is when nutrients are added to the environment around a plant. Fertilizers can be added to the water or a plant's growing surface, such as soil. Additional micronutrients and macronutrients can be added to the plant by the grower system.

Germination and seedling development can be split into four growing stages: imbibition, plateau, germination, and seedling. In some aspects, growth utilizing a hydroponic process may have different environmental settings during the growing stages than what is common for more developed plants. The different environmental settings may allow a plant to germinate and develop earlier, increase enzyme activity or increase dry matter. By controlling the environmental conditions utilizing a grower system 10, enzymes can be leveraged to increase carbohydrates and dry matter. The environmental conditions may vary based on plant type. Imbibition is the uptake of water by a dry seed. As the seed intakes the water, the seed expands, enzymes are released, and food supplies become hydrated. The enzymes become active, and the seed increases its metabolic activity. During imbibition the relative humidity is high and may range from 90% to 98% relative humidity. The temperature may range from 76° F. to 82° F. or 22° C. to 28° C. Air movement is minimal. The imbibition may last 18 to 24 hours. The plateau stage is where water uptake increases very little. The plateau stage is associated with hormone metabolism such as abscisic acid and gibberellic acid (GA) synthesis or deactivation. During the plateau stage humidity and temperature may be lower than the imbibition stage. Relative humidity may range from 70% to 90% and the temperature may range from 72° F. to 77° F. or 22° C. to 26° C. Air movement may still be minimal. The plateau stage may last 18-24 hours. Germination is the sprouting of a seed, spore, or other reproductive body. The absorption of water, temperature, oxygen availability, and light exposure may operate in initiating the process. During germination, the relative humidity may be lower than the imbibition and plateau stage. Relative humidity may range from 60% to 70%. The temperature may be the same as the plateau stage and range from 72° F. to 77° F. or 22° C. to 26° C. Air movement may be moderate. Germination may last 24 to 48 hours. The last phase is the seedling or plant development phase where the plant's roots develop and spread, and nutrients are absorbed fueling the plants rapid growth. The seedling stage may last until the plant matures. The seedling stage may also be broken down into additional phases: seedling, budding, flowering, and ripening. The relative humidity may be lowest at this stage and range from 40% to 60%. The temperature may also be the lowest at this stage and range from 68° F. to 72° F. or 20° C. to 22° C. Air movement is high. The seedling phase can range from 72 hours or until the plant reaches maturity.

Reactive oxygen species (ROS) are a type of unstable molecule that contains oxygen that can easily react with other molecules, such as a seed's coat, pathogens, or molecules within the cell. ROS can be formed due to the electron receptivity of O₂. ROS have important roles in functions such as signaling molecules that regulate normal plant growth and responses to stress. ROS are involved in photoprotection and a plant or seed's tolerance to different types of stress. However, too much ROS can cause damage to DNA, RNA, or other molecules as they oxidize, in some cases preventing cellular functions. Oxygen toxicity can arise both from uncontrolled production and from the inefficient elimination of ROS by antioxidants. During times of environmental stress such as UV exposure, heat exposure, drought, salinity, chilling, defense from pathogens, nutrient deficiency or other types of environmental stressors, ROS levels can naturally increase. ROS can include hydrogen peroxide (H₂O₂), hydroxyl radicals (OH), hypochlorous acid (HOCL), nitric acid (NO), peroxyl radical, including both alkylperoxyl and hydroperoxyl (ROO, R may be an H), peroxynitrite anion (ONOO⁻), oxygen (O₂), superoxide anion (O₂⁻), peroxide (O₂⁻²). H₂O₂ is moderately reactive and has a relatively long half-life allowing it to diffuse some distances from the original release site or site of production.

Internal ROS production in plants is mainly found in the chloroplast, mitochondria, and peroxisomes, but can also be found in the endoplasmic reticulum, cell membrane, cell wall and apoplast. The chloroplast photosystems, PSI and PSII, are major sources of internal ROS production. Abiotic stress factors lead to the formation of ROS through the Mehler reaction or the Fenton reaction and subsequently convert the O^{•-}₂ into H₂O₂. In the mitochondria, ROS are produced during normal conditions, but production is greatly increased by abiotic stress conditions. Peroxisomes are major sites of ROS production due to their oxidative metabolism. During stressful conditions, when the availability of water is low and stomata remains closed, increased photorespiration leads to glycolate formation. The glycolate is oxidized by glycolate oxidase in peroxisome to release H₂O₂, making it the leading producer of H₂O₂ during photorespiration. At times of adverse environmental conditions, stress signals combined with abscisic acid (ABA) make the apoplast a prominent site for H₂O₂ production inducing stomatal closure. The cell membrane provides information necessary for the survival of the plant cell. The electron transport system of the endoplasmic reticulum generates local ROS.

External ROS are ROS that are not internally produced by the plant or seed. External ROS can be externally applied to the plant or the seed of the plant by an applicator or introduced through a plant growing surface or soil. The external ROS can include a single type of ROS, such as H₂O₂, or a plurality of types of ROS, such as H₂O₂ and O₂⁻².

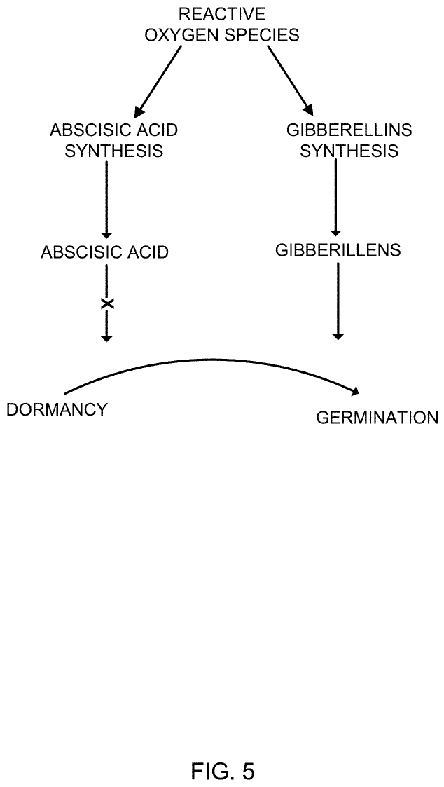

The accumulation of internal and external ROS within a plant, seed, or a cell leads to a variety of cellular responses. Plant responses may be ROS dose dependent. ROS allow for vital hormone balance. ROS can act as plant signalers, can cross bio membranes, and may inactivate or activate enzymes. Therefore, a controlled amount of ROS introduced to the plant may be necessary. ROS may oxidize ABA making ABA inactive. ROS may do so by activating gibberellin(s) (GA), as shown in FIG. 5.

ROS may interact with the outside chemistry of the seed or cell wall. Some seeds have a waxy outer coating which may contain chemicals or physical barriers that prevent germination or prevent water from entering the seed. Seeds with a waxy outer layer may include cereal grains such as wheat, barley, and rye. In some aspects, the 02 component of the ROS reacts with the cell wall or outer layer of the seed coat causing the cell wall or waxy outer layer to weaken, loosen or bubble thereby softening the cell wall. The ROS may even break the seed coat or cell wall open. ROS can also break down a cell wall by mediating poly saccharide deterioration and activating calcium channels and mitogen-activated protein kinases, enlarging and loosening the cell wall and causing weak points in the cell wall. External ROS can be introduced into a seed's environment to create weak spots in the seed coat allowing water to enter the seed more quickly. This may help the seed begin germinating. The creation of weak spots by the external ROS causes the seed to release additional internal ROS within the seed which interact with the interior of the cell wall or seed coat further weakening the wall. In the absence of ROS, the cell wall is strengthened and dormancy may continue.

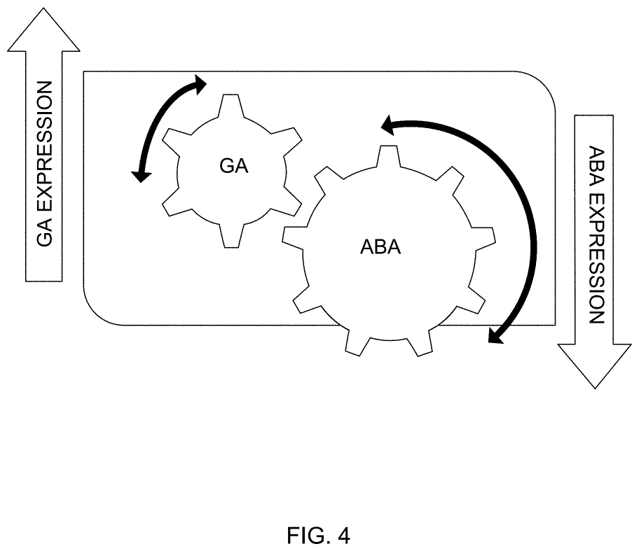

Phytohormones, such as abscisic acid (ABA), GA and ethylene (ET) regulate seed dormancy and seed germination as well as balance or dictate enzyme production. The ratio of ABA and GA regulates seed dormancy. When levels of ABA are high, stomatal closure, stress signaling, and delay in cell division are triggered downregulating metabolic and decreasing dry matter. High ABA/GA ratios favor dormancy, whereas low ABA/GA ratios result in seed germination. The increase in GA is necessary for seed germination to occur, as GA expression increases, ABA expression decreases, as shown in FIG. 4. The external introduction of ROS can jumpstart a seed's germination and end dormancy. ROS action during seed germination, as shown in FIG. 5, is based on interactions between phytohormones that regulate seed dormancy or seed germination such as ABA, GA, and ethylene (ET). ABA inhibits ROS-mediated effects on seed germination by the promotion of ROS scavenging enzyme activity. The ratio of ABA and GA regulates seed dormancy, as shown in FIG. 5. High ABA/GA ratios favor dormancy, whereas low ABA/GA ratios result in seed germination. High ABA/GA ratios can be counteracted by the controlled introduction of ROS into the soil or growing surface or directly onto the seed or plant. The ROS are absorbed by the seed or plant. GA can also counteract the ROS-scavenging enzymes by downregulating the enzymes. The ROS can also oxidize ABA as well, decreasing the amount of ABA to GA. In some cases, ROS can release seed dormancy by activating GA signaling and synthesis rather than the repression of ABA signaling or ABA catabolism. ROS then subsequently acts as a signal molecule to antagonize ABA signaling. External ROS can increase internal ROS content of a seed synthesizing or activating additional GA or repression of more ABA signals. The external application of ROS decreases ABA levels and increases GA concentrations, which triggers seed germination. However, the amount or concentration of ROS may need to be monitored. Above certain limits, ROS are either too low to allow germination or too high and affect embryo viability and therefore prevent or delay germination. This creates an ‘oxidative window’ for germination that restricts proficient seedling development within certain borders of increased ROS levels.

Through the application of ROS in hydroponic environments, the oxidative mode of action of gibberellins is mimicked in vivo supporting the release of hydrolytic enzymes from the aleurone layer and other plant cellular tissues. In addition, ligninolytic enzymes such as peroxidases favor delignification pathways when ROS are present in contrast to lignification reactions when ROS are absent. Delignification facilitated by ligninolytic enzyme hydrolysis supports improved fiber digestibility as lignin is generally regarded as the most complex and indigestible fiber complex in higher plants. The external ROS increases the amount of dry matter of hydroponically grown cellulosic materials and maximizes enzyme activity. In higher plants, enzyme release during the germination process is commonly controlled by the release of gibberellic acid (GA) from the embryo. Prior to photosynthesis, the rate of GA released is positively correlated to the metabolic needs of the juvenile plants. Larger metabolic needs signal increased rates of the release of gibberellic acid. The lignin peroxidase is energetically favored towards lignin deconstructive pathways rather than lignification.

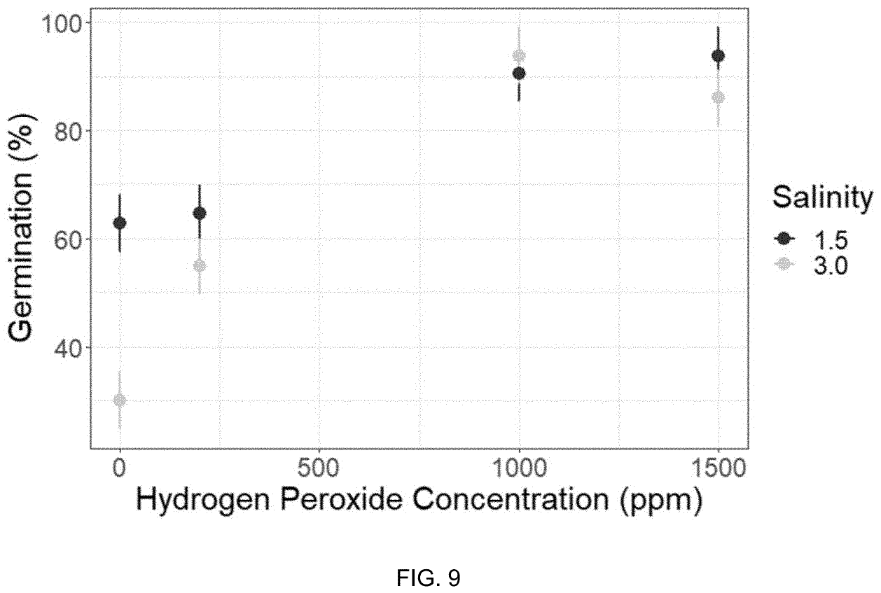

In hydrated seeds under aerobic conditions, ROS production and external ROS application correlates to increased metabolism in chloroplasts, mitochondria, glyoxysomes, peroxisomes, and the plasma membrane. During seed imbibition, compartmentalization of ROS in different subcellular structures and their target molecule regulates the expression of various genes. Water allows ROS to be transported or to travel over greater distances whereas in dry seeds ROS production must be near targets during seed imbibition. When a seed or plant is hydrated, external ROS may easily translocate from outside the cell, seed, or plant to the interior of the cell, seed, or plant increasing enzyme activity and dry matter. FIG. 9 illustrates the germination percentage of barley over differing H₂O₂ concentrations and salinity treatments. Salinity treatment may be expressed as salinity concentration in parts per thousand. The values shown in FIG. 9 are expressed in a fixed effect linear model estimation with 95 percent confidence interval illustrating the surrounding estimate. Through the application of ROS, the inhibitory influence of ABA included reduced stem elongation, and germination is reduced.

GA triggers cell division, stem elongation, and root development. Enzyme expression is closely linked to metabolic needs during germination. As the plant becomes metabolically active shortly after imbibition, GA is released from the seed embryo signaling the release of a wide profile of enzymes from within the seed including from the aleurone layer surrounding the polysaccharide and protein rich endosperm of the seed. During germination, GA translocates to and interacts with the aleurone layer, thereby releasing or synthesizing hydrolytic enzymes, included α-amylase. The term “amylase” means an enzyme that hydrolyzes 1,4-alpha-glucosidic linkages in oligosaccharides and polysaccharides, including the following classes of enzymes: alpha-amylase, beta-amylase, glucoamylase, and alpha-glucosidase.

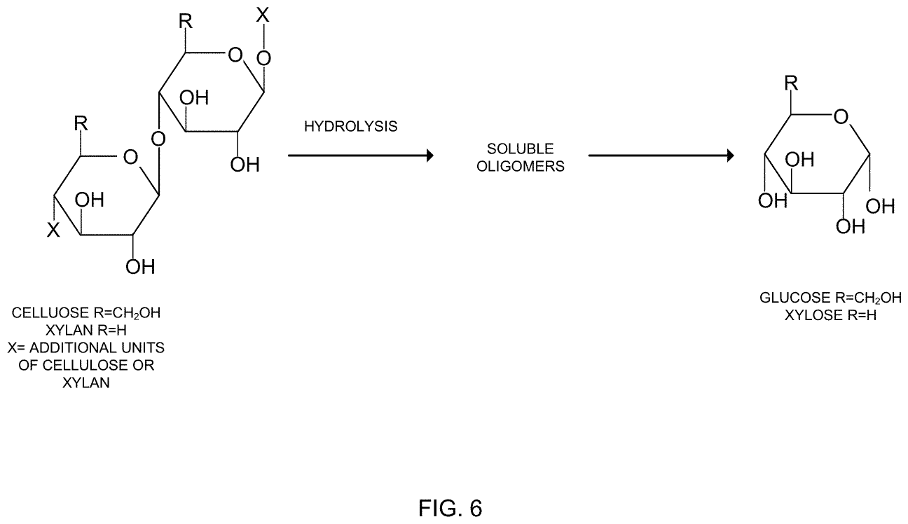

Hydrolytic enzymes are some of the most energy efficient enzymes. The hydrolytic enzymes, such as 1,3;1,4-β-glucanase (β-glucanase), α-amylase and β-amylase, are released. The term “beta-glucosidase” means a beta-D-glucoside glucohydrolase that catalyzes the hydrolysis of terminal non-reducing beta D-glucose residues with the release of beta-D-glucose. Once the hydrolytic enzymes are released, they facilitate the hydrolysis of complex storage molecules including cell wall polysaccharides, proteases, storage proteins, and starchy energy reserves that are essential for germination, providing sugars that drive the root growth, into their simpler monomer subunits. Hydrolysis of the storage molecules is one of the primary energy sources of plants. The hydrolytic enzymes break the polymers into dimers or soluble oligomers and then into monomers by water splitting the chemical bonds, as shown in FIG. 6.

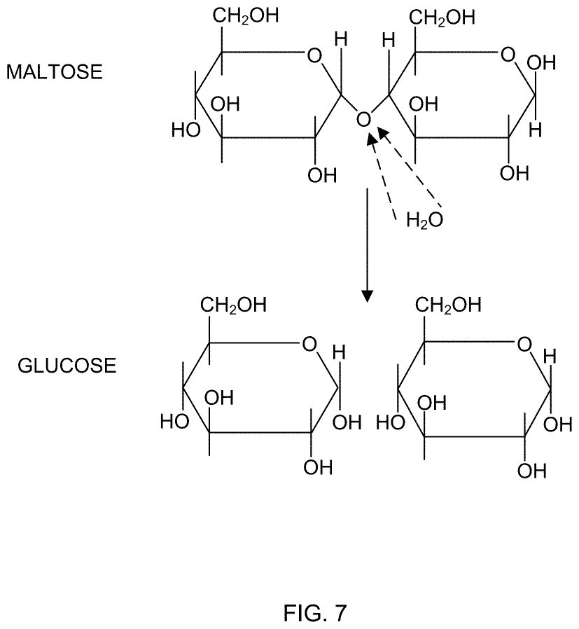

B-glucanase may hydrolyze 1,3;1,4-β-glucan, a predominant cell wall polysaccharide. The α-amylase cleaves internal amylose and amylopectin residues. The β-amylase exo-hydrolase liberates maltose and glucose from the starch molecules as shown in FIG. 7. These reduced nutrient forms are commonly then transported back to the embryo where glycolysis and the cellular respiration pathway uses glucose to produce ATP needed for energy intensive cellular division and biosynthesis reactions. As the metabolic needs of the juvenile plant increases, the release of GA from the seed embryo and the release of enzymes from the aleurone layer likewise increases. Enzyme activity within the juvenile plant peaks at the onset of efficient photosynthesis. At this point, the total metabolic demands of the plant are not able to be met by photosynthesis and a large amount of storage molecules must be hydrolyzed to glucose for glycolysis and ATP generation.

Most mammals have a hard time digesting dietary fibers including cellulose. Cellulose polysaccharides are the prominent biomass of the primary cell wall, followed by hemicellulose and pectin. Cellulosic material is any material containing cellulose. The secondary cell wall, produced after the cell has stopped growing, also contains polysaccharides and is strengthened by polymeric lignin covalently cross-linked to hemicellulose. Cellulose is a homopolymer of anhydrocellobiose and is a linear beta-(1-4)-D-glucan. Hemicellulose can include a variety of compounds, such as, Xylans, Xyloglucans, arabinoxylans, and mannans in complex branched structures with a spectrum of Substituents. Cellulose, although polymorphous, is primarily found as an insoluble crystalline matrix of parallel glucan chains. Hemicellulose usually hydrogen bonds to cellulose as well as other hemicelluloses, stabilizing the cell wall matrix. Cellulolytic enzymes or cellulase mean one or more enzymes that hydrolyze a cellulose material. The enzymes may include endoglucanase(s), cellobiohydrolase(s), beta-glucosidase(s), or combinations thereof. The enzymes break the cellulosic material down into cellodextrin or completely into glucose. Hemicellulolytic enzyme or hemicullase are one or more enzymes that hydrolyze a hemicellulosic material forming furfural or arabinose and xylose.

Beta-xylosidase, or beta-D-xyloside xylohydrolase, catalyzes the exo-hydrolysis of short beta (1->4)-xylooligosaccharides to remove successive d-xylose residues from non-reducing termini and may hydrolyze xylobiose. Beta-xylosidase engage in the final breakdown of hemicelluloses. The term “xylanase” means a 1,4-beta D-xylan-Xylohydrolase that catalyzes the endohydrolysis of 1,4-beta-D-Xylosidic linkages in Xylans. The term “endoglucanase” means an endo-1,4-(1,3:1,4)-beta-D-glucan 4-glucanohydrolase that catalyzes endohydrolysis of 1,4-beta-Dglycosidic linkages in cellulose, cellulose derivatives (such as carboxymethyl cellulose and hydroxyethyl cellulose), lichenin, beta-1,4 bonds in mixed beta-1,3 glucans such as cereal beta-D-glucans or Xyloglucans, and other plant material containing cellulosic components.

Lignin is another primary component of the cell wall. Lignin is a class of complex polymers that form key structural materials in support tissues, such as the primary cell wall, in most plants. The lignols that crosslink to form lignin are of three main types, all derived from phenylpropane: coniferyl alcohol (4-hydroxy-3-methoxyphenylpropane), sinapyl alcohol (3,5-dimethoxy-4-hydroxyphenylpropane), and paracoumaryl alcohol (4-hydroxyphenylpropane. Lignin fills the spaces in the cell wall between cellulose, hemicellulose, and pectin components. It can covalently crosslink to hemicellulose mechanically strengthening the cell wall. Ligninolytic enzymes are enzymes that hydrolyze lignin polymers. The ligninolytic enzymes include lignin peroxidases, manganese peroxidases, laccases and feruloyl esterase, and other enzymes described in the art known to depolymerize or otherwise break lignin polymers. Also included are enzymes capable of hydrolyzing bonds formed between hemicellulosic sugars (notably arabinose) and lignin.

During stress, the cell wall-localized lipoxygenase causes hydroperoxidation of polyunsaturated fatty acids (PUFA) making it an active source of ROS. During a pathogen attack, lignin precursors undergo extensive cross-linking, via ROS-mediated pathways to reinforce the cell wall with lignin. Lignin fills the spaces in the cell wall between cellulose material, hemicellulose, and pectin components, especially in vascular and support tissues: xylem tracheids, vessel elements and sclereid cells. If external ROS are applied to the seed or plant, the external ROS may disinfect the seed or plant or kill some or all of the pathogens. This stops lignin precursors from cross-linking and strengthens the cell wall preventing germination or the growth of the plant.

Lignin depolymerization can be achieved primarily by one-electron oxidation reactions catalyzed by extracellular oxidases and peroxidases in the presence of extracellular ROS or external ROS. Hydroxyl radicals attack the lignin structures, creating access points for hydrolysis by whole cells, enzymes, or other chemicals. External application of ROS allows additional ROS to attack the lignin structures, creating additional access points for hydrolysis lignin, cellulose and hemicellulose by ligninolytic enzymes, hemicellulolytic enzymes or hemicellulose, cellulolytic enzymes or cellulase, and endoglucanase.

Lipids are used as structural components to limit water loss and pathogen infection. These lipids include waxes derived from fatty acids, as well as cutin and Suberin. Lipase is an enzyme that hydrolyzes lipids, fatty acids, and acylglycerides, including phosphoglycerides, lipoproteins, diacylglycerols, and the like. Lipases include the following classes of enzymes: triacylglycerol lipase, phospholipase A2, lysophospholipase, acylglycerol lipase, galactolipase, phospholipase A1, dihydrocoumarin lipase, 2-acetyl-1-alkylglycerophosphocholine esterase, phosphatidylinositol deacylase, cutinase, phospholipase C, phospholipase D, 1-hosphatidylinositol phosphodiesterase, and alkylglycerophospho ethanolamine 19-hosphodiesterase. Lipase increases the digestibility of lipids by breaking lipids down digestibly into saccharides, disaccharides, and monomers.

Phytate is the main storage form of phosphorous in plants. However, many animals have trouble digesting or are unable to digest enzymes because they lack enzymes that break phytate down. Because phosphorus is an essential element, inorganic phosphorous is usually added to animal feed. Phytase is a hydrolytic enzyme that specifically acts on phytate, breaking it down and releasing organic phosphorous. The term “phytase” means an enzyme that hydrolyzes ester bonds within myo-inositol-hexakisphosphate or phytin. Including 4-phytase, 3-phytase, and 5-phyates. By increasing the activity of the hydrolytic enzymes, organic phosphorous is released and inorganic phosphorous does not have to be added to animal feed.

Protease breaks down proteins and other moieties, such as sugars, into smaller polypeptides and single amino acids by hydrolyzing the peptide bonds. Many of the proteins serve as storage proteins. Some specific types of proteases include cysteine proteases including pepsin, papain, and serine proteases including chymotrypsins, carboxypeptidases, and metalloen dopeptidases. Proteases play a key role in germinations through the hydrolysis and mobilization of proteins that have accumulated in the seed. Proteases also play a role in programmed cell death, senescence, abscission, fruit ripening, plant growth, and N homeostasis. In response to abiotic and biotic stresses, proteases are involved in nutrient remobilization of leaf and root protein degradation to improve yield.

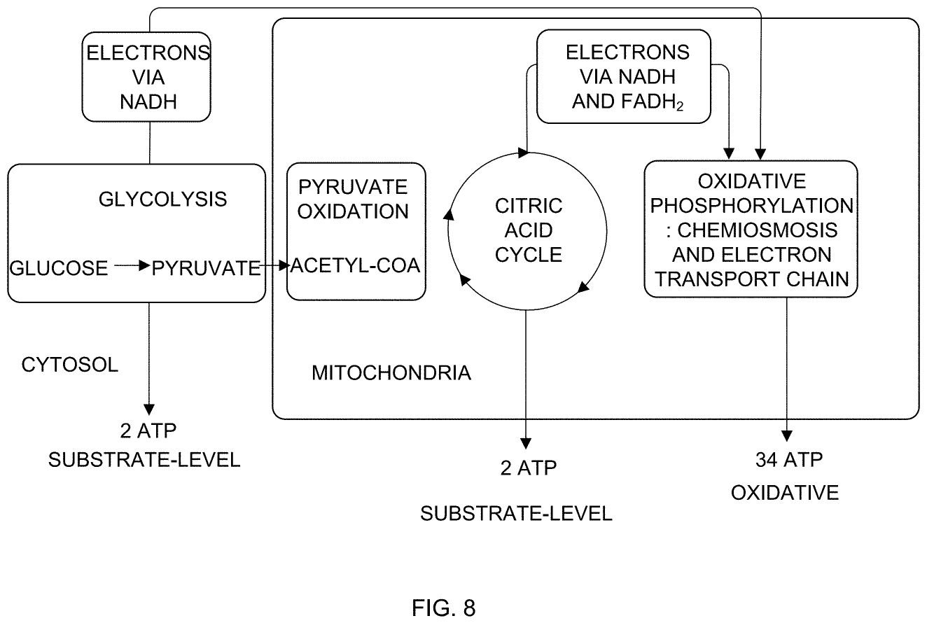

Cellular respiration is a set of metabolic reactions that take place in the cells of the seed to convert chemical energy from oxygen molecules or nutrients into adenosine triphosphate (ATP), as shown in FIG. 8. Nutrients, such as sugar, amino acids and fatty acids are used during cellular respiration. Oxygen is the most common oxidizing agent. Aerobic respiration requires oxygen to create ATP and is the preferred method of pyruvate in the breakdown into glycolysis. The energy transferred is used to break bonds in adenosine diphosphate (ADP) to add a third phosphate group to form ATP by phosphorylation, nicotinamide adenine dinucleotide (NADH) and flavin adenine dinucleotide (FADH₂). NADH and FADH₂ is converted to ATP using the electron transport chain with oxygen and hydrogen being the terminal electron acceptors. Most of the ATP produced during aerobic cellular respiration is made by oxidative phosphorylation. Oxygen releases chemical energy which pumps protons across a membrane creating a chemiosmotic potential to drive ATP synthase.

Aerobic metabolism is much more efficient than anaerobic metabolism which yields 2 molecules of ATP per 1 molecule of glucose instead of 34 molecules of ATP per 1 molecule of glucose. The double bond in oxygen has higher energy than other common biosphere molecule's double bonds or single bonds. Aerobic metabolism continues with the critic acid or Krebs cycle and oxidative phosphorylation.

The efficiency of plant cellular respiration is influenced by the availability of oxygen. Specifically, the oxidative phosphorylation metabolic pathway or the electron transport-linked phosphorylation pathway requires the presence of oxygen for transfer of electrons from NADH or FADH₂. Hypoxic conditions expected while sprouting seedlings in a saturated environment or in a compressed environment, such as in a pan system with no room for expansion, thereby directly limit the maximum efficiency of oxidative phosphorylation. Processes allowing for the germination of grains with water drainage and space for seed expansion may facilitate increased available oxygen concentrations throughout development. Encouraging the efficiency of oxidative phosphorylation enables dry matter to increase through the buildup of monomers such as glucose. When complex molecules such as oligosaccharides are hydrolyzed into their simpler monomer units, chemical energy from the water molecule is converted into a dry matter form, as shown in FIG. 6. The cleavage of the water molecule and the disaccharide's oxygen bond enables the transformation of chemical energy within water to metabolically available forms. Utilizing the monomers in the most efficient manner enables increasing enzyme release which increases dry matter at the onset of efficient photosynthesis.

Glycolysis occurs with or without the presences of oxygen. Under aerobic conditions the process converts one molecule of glucose into two molecules of pyruvate (pyruvic acid) and 2 molecules of ATP. The initial phosphorylation of glucose is required to increase the reactivity in order for the molecule to be cleaved into two pyruvates by the enzyme aldolase. During the pay-off phase of glycolysis, four phosphate groups are transferred to ADP by substrate-level phosphorylation to make four ATP, and two NADH are produced when the pyruvate is oxidized. The citric acid cycle produces acetyl-CoA from the pyruvate molecules when oxygen is present. The acetyl-CoA is oxidized to CO₂ and NAD is reduced to NADH which can be used by the electron transport chain to create further ATP. If oxygen is not present, acetyl-CoA is fermented.

Oxidative phosphorylation comprises the electron transport chain and establish a chemiosmotic potential or proton gradient by oxidizing NADH produced during the citric acid cycle. ATP is synthesized using the ATP synthase enzyme where the chemiosmotic potential is used to drive the phosphorylation of ADP. The electron transfer is driven by the chemical energy provided from exogenous oxygen.

The ROS may oxidize the pericarp of a plant ovary. The pericarp is the ripened and variously modified walls of a plant ovary. The pericarp has an outer exocarp, a central mesocarp, and an inner endocarp, and this is the wall of a plant fruit that develops from the ovary wall. External ROS may trigger redox signaling during plant organ development including fruit ripening and flower development. Oxidative stress, the imbalance between ROS production and ROS elimination, occurs in the mitochondria due to increased respiratory rates during ripening affecting the redox state once sugars become a limiting factor and onset ripening. External ROS can increase the imbalance allowing the plant to ripen. Oxidative stress also occurs in the plastid during the chloroplast to chromoplast transition at the onset of fruit ripening.

By decreasing environmental stresses and increasing metabolic activity, the plant can be harvested in an interval that closely aligns with the maximum point of enzyme activity within the plant's life cycle and increased development results. Harvesting the plant at the maximum point of enzyme activity allows for maximum break down of proteins during phase one of ensiling increasing dry matter, shelf life, and quality of the ensiled animal feed.

The nutrient or mineral content of animal feed or plant tissues may be expressed on a dry matter basis or the proportion of the total dry matter in the material. When enzyme activity is maximized the dry matter ratio can increase, such as by 118% in barley and 115% in wheat, instead of by 92% or 95%. The harvested product is rich in enzymes. Based on enzyme values reported when investigating the malting characteristics of cereals, barley is estimated to have approximately 12,000 kilo novo units (KNO) of amylase activity per kg dry matter, 400 units of protease per milligram protein and 200 units of lipase per milligram protein. Wheat is expected to have amylase levels approximately 50% to 75% the amount of barley on average with lipase and protease values equal and 100% greater, respectively. Enzymes, such as peroxidase and hemicellulose, relating to fiber catabolism are likely also very active during the first stages of the ensiling process due to the decrease in environmental stresses.

For example, barley harvested at the maximum point of enzyme activity, the amount of apparent crude protein increases. Apparent crude protein is the content of the animal feed or plant same that represents the total nitrogen, including true protein and non-protein nitrogen (urea and ammonia). Apparent crude protein is an important indicator of the protein content of a forage crop. In one example the apparent crude protein in barley can be increased by 143% instead of 117% and 125% when harvested on day six, when enzyme activity was maximized. In another example, wheat may be harvested at the maximum enzyme point, such as day six, and the amount of apparent crude protein can be increased by 129%. The neutral detergent fiber digestibility (NDFd) or neutral detergent fiber (NDF) of a crop, plant, or feed sample content is a close estimate of the total fiber constituents of the crop. The NDF contains plant cell wall components such as cellulose, hemicellulose, lignin, silica, tannins, and cutins, and it does not include some pectins. The structural carbohydrates, hemicellulose, cellulose, and lignin, represent the fibrous bulk of the crop. Though lignin is indigestible, hemicellulose and cellulose can be (in varying degrees) digested by microorganisms in animals with either a rumen, such as cattle, goats or sheep, or hind-gut fermentation such as horses, rabbits, guinea pigs, as part of their digestive tract. NDF is considered to be negatively correlated with dry matter intake, as the percentage of NDF increases the animals consume less of the crop. In one example the NDF in barley can be increased by 178% instead of from 132% and 155% when harvested on day six when enzyme activity is maximized. In another example, when wheat may be harvested at the maximum enzyme point, such as day six, the amount of NDF can be increased by 173%. Water-soluble carbohydrates (WSC) are carbohydrates that can be solubilized and extracted in water. WSC's can include monosaccharides, disaccharides, and a few short chain polysaccharides, such as fructans, which are major storage carbohydrates. In one example the WSC in barley increased by 442% instead of from 182% and 191% when harvested on day six when enzyme activity was maximized. In another example, when wheat may be harvested at the maximum enzyme point, such as day six, the amount of WSC can be increased by 553%. The increase in percentage is evidence that by increasing the enzyme activity in plants, complex storage molecules are being broken down into simpler monomer storage molecules increasing nutrient digestibility. Starch is an intracellular carbohydrate found primarily in the grain, seed, or root portions of a plant as a readily available source of energy. In crops where GA activity increases, the amount of starch present in the feed is reduced. This may be due to the breakdown of starch into simpler sugars, such as glucose and maltose, by the enzymes increasing nutrient digestibility of the feed. When enzyme activity is maximized, the amount of starch in barley can be increased by 17% and by 26% in wheat. Dry matter refers to all the plant material excluding water. The nutrient or mineral content of animal feed or plant tissues may be expressed on a dry matter basis or the proportion of the total dry matter in the material. When enzyme activity is maximized the dry matter ratio can increase, such as by 118% in barley and 115% in wheat, instead of by 92% or 95%. These increases allow for increased nutrient and dry matter in the ensiled cellulosic material. The maximization of the enzyme activity may limit the amount of dry matter and nutrient availability lost during the ensiling process.

The breakdown of storage molecules into nutrient digestible monomer subunits can be increased by leveraging GA in a hydroponic environment. When GA activity is increased in crops, the crude protein content can increase, such as from 15.9% to 20.4% in rye. When ABA activity is increased the crude protein content decreases, for example, from 15.9% to 13.7%. Crude protein content in a crop, plant, or feed sample represents the total amount in nitrogen in the diet, including protein and non-protein nitrogen. The fibrous component of a crop, plant or feed sample content represents the least digestible fiber portion. The least digestible portion includes lignin, cellulose, silica, and insoluble forms of nitrogen. Hemicellulose is not included in the least digestible portion. Crops with a higher acid detergent fiber (ADF) have a lower digestible energy. As the ADF level increases, the digestible energy level decreases. When GA activity is increased, the ADF percentage increases, such as from 9.2% to 12.8% in rye. When ABA activity increases, the ADF percentage decreases, such as from 9.2% to 4.2%. In crops where the GA activity increases the percentage of NDF increases, such as from 21.6% to 27.1% in rye. In crops, where ABA activity increases, the NDF percentage decreases, such as from 21.6% to 15.2% in rye. The ethanol soluble carbohydrates (ESC) of a plant include monosaccharides, such as glucose and fructose, and disaccharides. When GA activity increases the ESC percentage decreases slightly, as energy is needed to grow the plant or crops. In rye the ESC percentage may decrease from 35.3% to 31.7%. In rye the starch percentage decreased from 19.1% to 9.6%. However, when ABA activity increased due to environmental stressors, the amount of starch in the rye increased from 19.1% to 42.2%. Crude fat is an estimate of the total fat content of the crop or feed sample. Crude fat contains true fat (triglycerides), alcohols, waxes, terpense, steroids, pigments, ester, aldehydes, and other lipids. In feed samples where GA activity was increased due to reducing environmental stresses, the amount of crude fat increased. In Rye crops the crude fat may increase from 1.39% to 2.78%. Crude fat also increases when ABA activity increases. In rye crops the crude fat percentage may increase from 1.39 to 1.44%. By breaking down the storage molecules earlier in the development of the plant or by maximizing enzyme activity the heat generated during fermentation or the aerobic phase of ensiling is limited or nonexistent.

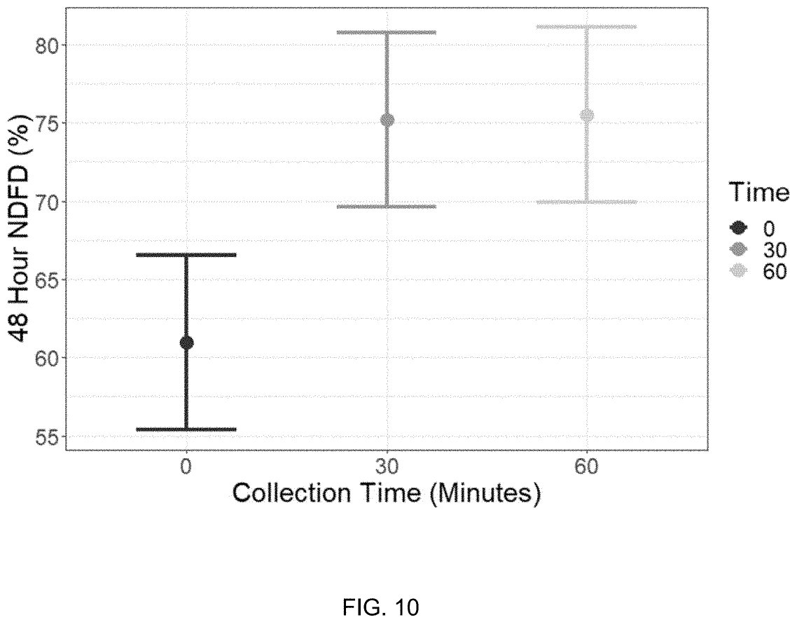

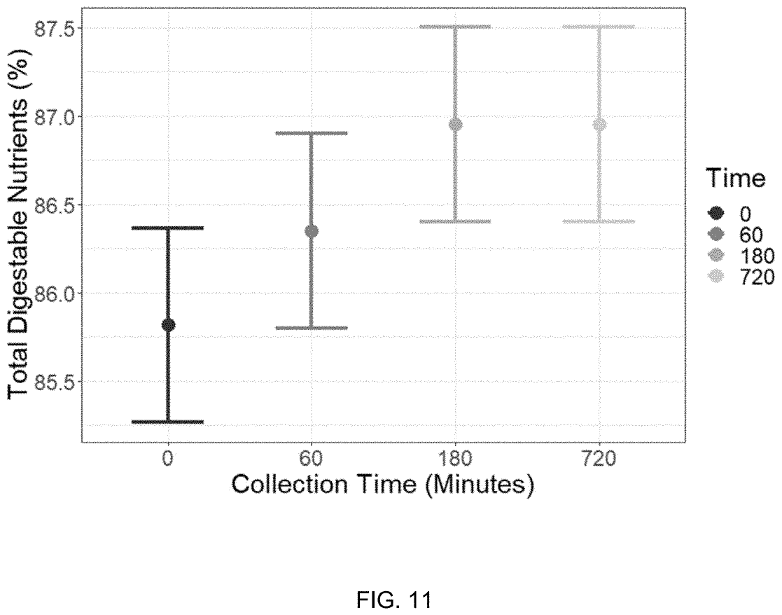

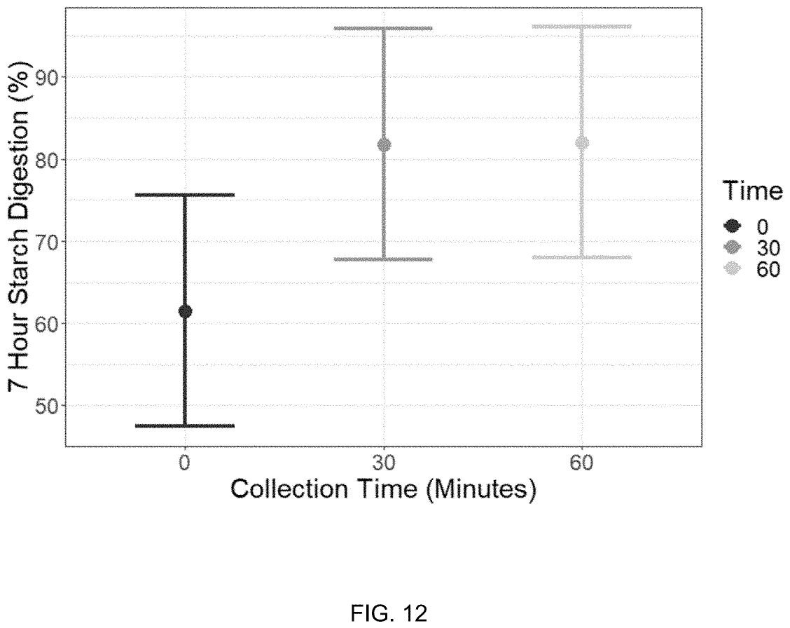

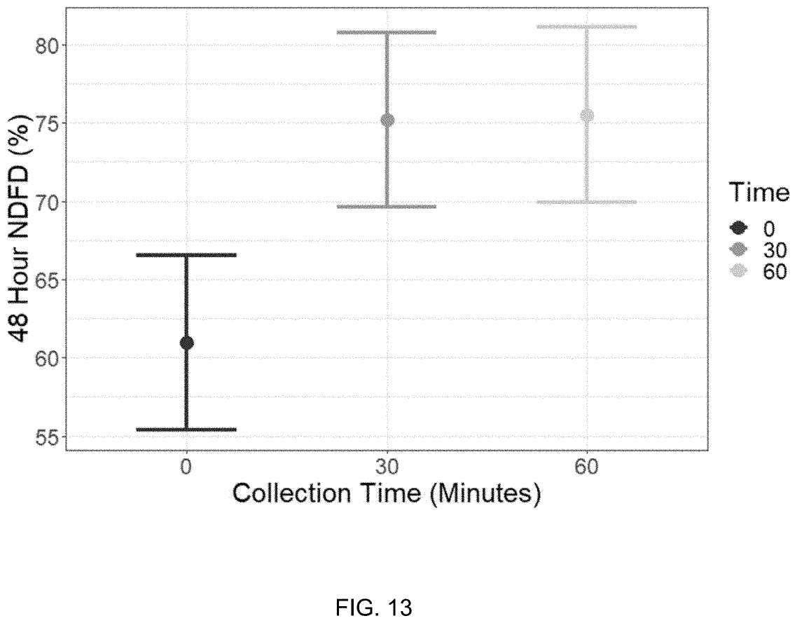

FIG. 13 illustrates in vitro 48-hour digestible NDF fraction expressed as a percentage over three mix collection timepoints. Values expressed as fixed effect linear model estimation with 95% confidence interval illustrated surrounding estimate. Samples collected at time points depicted below after 25% hydroponically grown wheat was mixed with 75% corn dry distiller grains on a dry matter basis. The percentage of NDF increases as the samples are collected later, allowing the plant's naturally produced enzymes to increase the digestibility of NDF. FIG. 12 illustrates in vitro 7-hour starch digestion expressed as a percentage over three mix collection timepoints. Values expressed as fixed effect linear model estimation with 95% confidence interval illustrated surrounding estimate. Samples collected at time points depicted below after 25% hydroponically grown wheat was mixed with 75% corn dry distiller grains on a dry matter basis. The starch digestion increases as the enzymes are leveraged to increase nutrient digestibility. FIG. 11 illustrates the estimated total digestible nutrient percentage over four mix collection timepoints. Values expressed as fixed effect linear model estimation with 95% confidence interval illustrated surrounding estimate. Samples collected at time points depicted are after 25% hydroponically grown barley was mixed with 75% cracked corn on a dry matter basis. FIG. 10 illustrates the In vitro 48-hour digestible NDF fraction expressed as a percentage over three mix collection timepoints. Values expressed as fixed effect linear model estimation with 95% confidence interval illustrated surrounding estimate. Samples collected at time points depicted are after 25% hydroponically grown wheat was mixed with 75% corn silage on a dry matter basis.

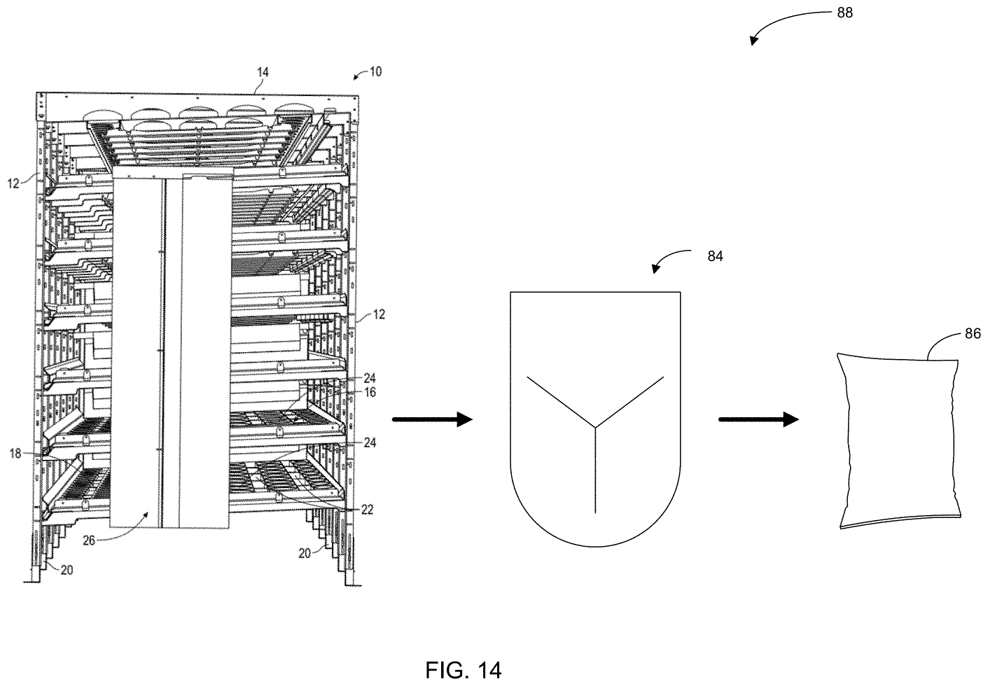

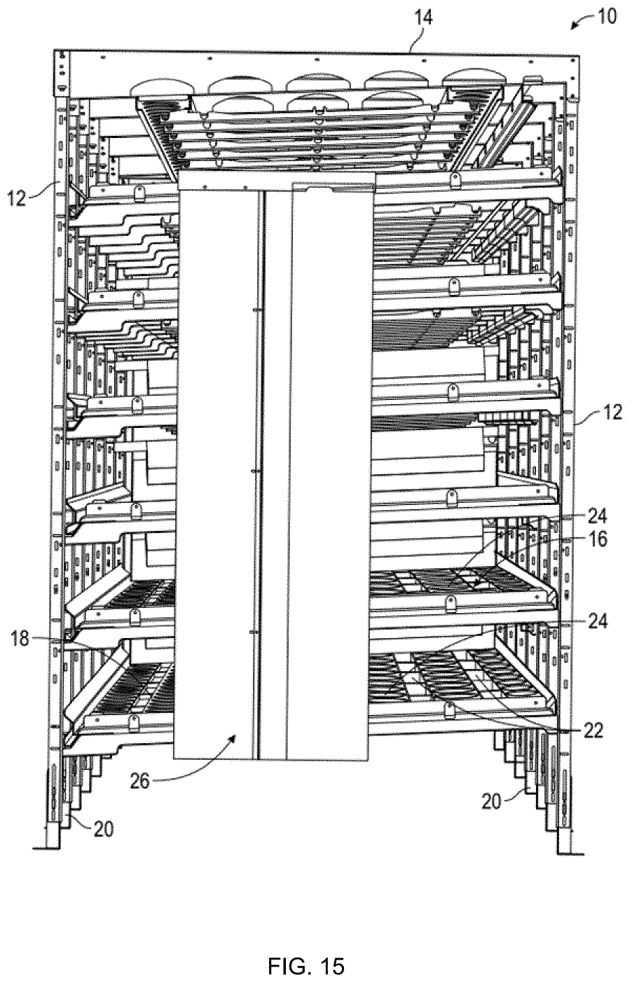

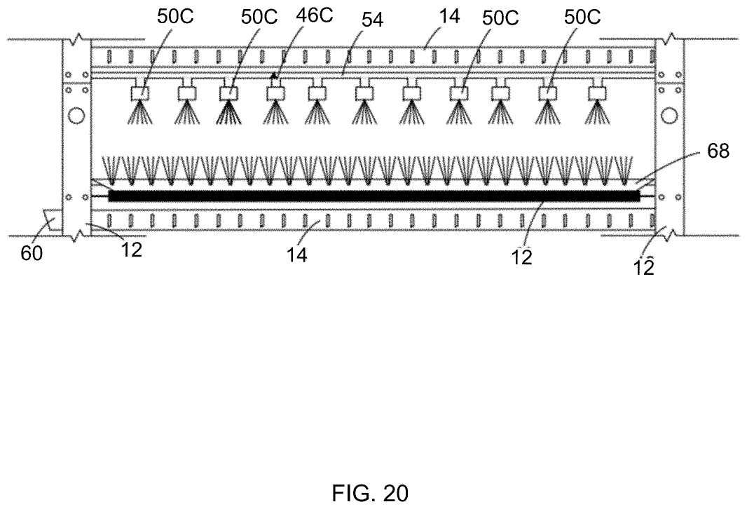

FIG. 14 illustrates an ensiling system 88 that may include a grower system 10, an ensiling apparatus 84, and a seal environment 86 such as a bag. The grower system 10 can provide aerobic conditions allowing the plant to increase dry matter and maximize enzyme activity thereby improving the quality of the ensiled animal feed. The grower system 10, shown in FIGS. 14-22 may include a plurality of vertical members 12 and a plurality of horizontal members 14 removably interconnected to form an upstanding seed growing table 16 with one or more seed beds 18. In some aspects of the present disclosure, the grower system 10 may have one or more seed beds 18. Each vertical member 12 can be configured to terminate at the bottom in an adjustable height foot 20. Each foot 20 can be adjusted to change the relative vertical position or height of one vertical member 12 relative to another vertical number 12 of the seed growing table 16. The horizontal member 14 can be configured to include one or more lateral members removably interconnected with one or more longitudinal members 24. A pair of vertical members 12 may be separated laterally by a lateral member 22 thereby defining the width or depth of the seed growing table 16. Longitudinal members 24 may be removably interconnected with lateral members 22 by one or more connectors 26.

Each seed bed 18 may include a seed belt 28, such as a seed film, operably supported by seed growing table 16. Seed belt 28 can be configured according to the width/depth of seed growing table 16. By way of example, the width/depth of seed belt 28 can be altered according to changes in the width/depth of seed growing table 16. The seed belt 28 material can be hydrophobic, semi-hydrophobic or permeable to liquid. In at least one aspect, a hydrophobic material may be employed to keep liquid atop the seed belt 28. In another aspect, a permeable or semi-permeable material can be employed to allow liquid to pass through the seed belt 28. Advantages and disadvantages of both are discussed herein. Traditional pans use hydrophobic material as part of the seed bed. This may increase water stress as water stays within the seed bed for prolonged periods, creating hypoxic conditions and increasing the concentration of ABA. The seeds use up the available oxygen. In one aspect, seed belt 28 may be discontinuous and may have separate or separated terminal ends. The seed belt 28 may have a length of at least the length of the seed bed 18 and generally a width of the seed bed 18 and may be configured to provide a seed bed for carrying seed. The seed belt 28 may be configured to move across the seed bed 18. Seed belt 28 may also rest upon and slide on top of horizontal members 14. One or more skids or skid plates (not shown) may be disposed between seed belt 28 and horizontal members 14 to allow seed belt 28 to slide atop horizontal members 14 without binding up or getting stuck. The seed bed 18 or seed belt 28 may be positioned at a slope to encourage the drainage of water facilitating an increased oxygenated environment when compared to a pan type fodder set up.

To provide room for expansion the seed belt 28 or seed bed 18 may have a seed egress 68 on one or more sides of the seed bed 18, such as a first side 70 and an opposing second side 72. The seed egress 68 allows room for expansion as the seeds 74 grow, lessening the growth compression of the seeds 74. If the seed bed 18 has walls on the first side 70 or the second side 72, the walls may prevent the seeds 74 from expanding thereby compressing some or all of the seeds. The compressed seeds may receive little to no oxygen resulting in hypoxic or anaerobic conditions. The seed egress 68 may not be covered with seeds during seed out. The empty space allows for expansion as the seed doubles in volume in the first few growth stages, such as in the first 24 hours. If the seeds do not have room to expand, the seed may be subjected to a dense environment with reduced heat, water, and oxygen exchange capabilities.

Each seed bed 18 may include a liquid applicator 46A, 46B, and/or 46C operably configured atop each seed bed 18 for irrigating seed disposed atop each seed bed 18. The seed may be irrigated with water. The dimensions of the seed bed 18 may be configured to accommodate need, desired plant output, or maximization of enzyme activity. Liquid applicator 46A may be configured adjacent at least one longitudinal edge of seed bed 18. Liquid applicator 46A may also be operably configured adjacent at least one lateral edge of seed bed 18. Preferably, liquid applicator 46A may be configured adjacent a longitudinal edge of seed bed 18 to thereby provide drip-flood irrigation to seed bed 18 and seed 74 disposed atop seed bed 18. Liquid applicator 46A may include a liquid guide 48 and liquid distributor 50A, 50B, 50C with a liquid egress 52 having a generally undulated profile, such as a sawtooth or wavy profile generally providing peak (higher elevated) and valley (lower elevated) portions. Liquid applicator 46A can include a liquid line 54 configured to carry liquid 62 from a liquid source 56, such as a liquid collector 58 or plumbed liquid source 56. Liquid 62 may exit liquid line 54 through one or more openings and may be captured upon exiting liquid line 54 by liquid guide 48 and liquid distributor 50A. The one or more openings in liquid line 54 can be configured as liquid drippers, intermittently dripping a known or quantifiable amount of liquid 62 over a set timeframe into liquid guide 48. The one or more openings may be configured intermittently along a length of liquid line 54 or dispersed in groupings along a length of liquid line 54. The one or more openings in liquid line 54 can be operably configured to equally distribute the liquid 62 down the seed bed 18 and slowly drip liquid into the seed bed 18. Drip or flood irrigating the growing surface provides a layer of liquid 62 for soaking the seed and can provide liquid 62 to seed 74 on seed bed 18 in a controlled, even distributive flow. Liquid distributor 50A can be configured with a liquid guide 48 adapted to collect liquid 62 as it exits liquid line 54. Collected liquid may be evenly distributed by liquid distributor 50A and exit the liquid distributor 50A onto the seed bed 18 via the liquid egress 52.

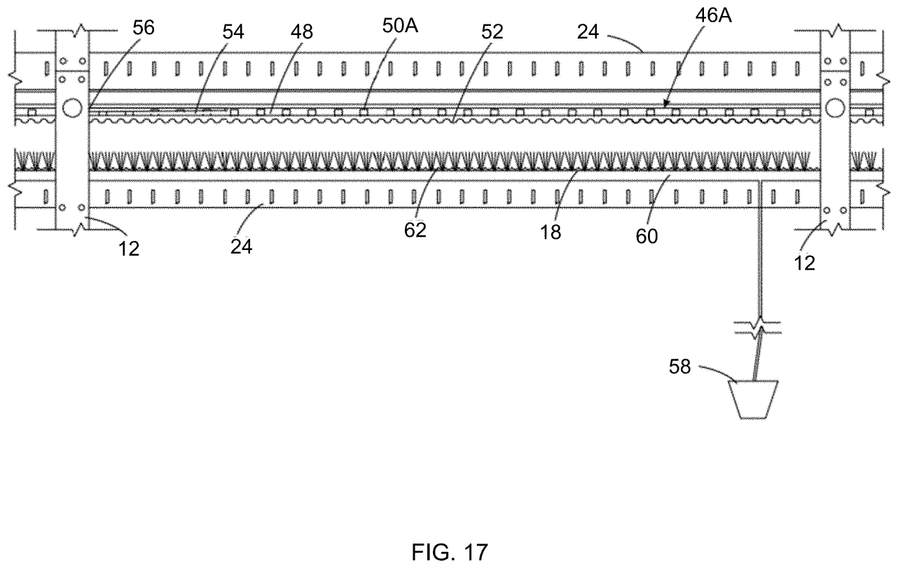

According to at least one aspect, liquid 62 egressing from liquid distributor 50A may travel atop seed belt 28 beneath and/or between a seed mass 74 atop seed belt 28 as shown in FIG. 17. Other configurations of liquid applicator 46 are also contemplated herein. For example, in one aspect, liquid 62 may enter liquid applicator 46 through a liquid line 54 and exit liquid line 54 through a plurality of openings. Liquid 62 from liquid line 54 may coalesce into a small reservoir creating a balanced distribution of liquid 62 across a length of liquid distributor 50A. When this small reservoir becomes full, the liquid 62 may run over and out of liquid egress 52, such as between the teeth of liquid egress 52. In this manner, liquid 62 may be equally distributed down an entire length and across an entire width of the seed bed 18. From liquid egress 52, liquid 62 may drip onto a seed belt 28 where it may run under a bulk of seed on the seed belt 28 to soak or make contact with the seed 74. The root system of seed 74 on the seed belt 28, along with a wicking effect, may move the liquid 62 up through the seed to water all the seeds and/or plants.

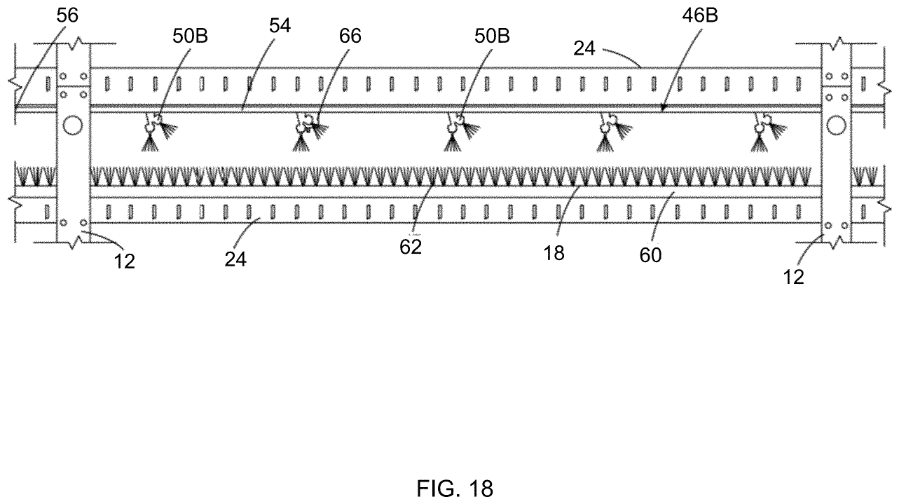

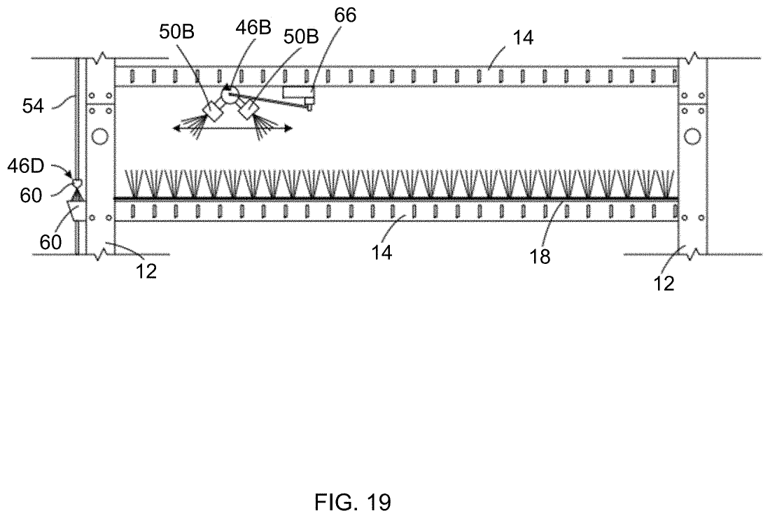

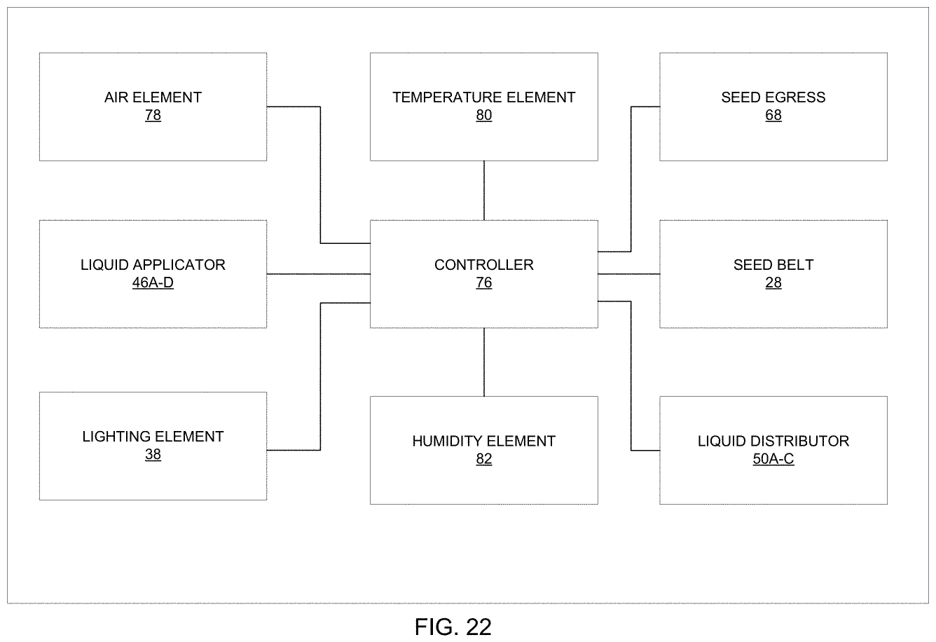

Liquid applicator 46B may be disposed atop each seed bed 18. Liquid applicator 46B may include a plurality of liquid distributors 50B operably configured in a liquid line 54 operably plumbed to a liquid source 56. Liquid distributor 50B can include spray heads, such as single or dual-band spray heads/tips, for spray irrigating seed disposed atop each seed bed 18. In one aspect, a plurality of liquid lines 54 may be disposed in a spaced arrangement atop each seed bed 18. Each liquid line 54 may traverse the length of the holding container and may be plumbed into connection with liquid source 56, as shown in FIG. 18. Other liquid lines 54 can be configured to traverse the width of seed bed 18. Liquid 62 may be discharged from each liquid distributor 50B for spray irrigating seed atop each seed bed 18. In another aspect, each liquid line 54 may be oscillated back and forth over a 10°, 15°, 20°, 25°, 30°, 35°, 40°, 45°, or greater radius of travel for covering the entire surface area of the seed atop each seed bed 18. In the case where dual angle spray heads may be used for liquid distributor 50B, the oscillation travel of each liquid line 54 can be reduced thereby reducing friction and wear and tear on liquid applicator 46B. The process of applying liquid to the seed or plant can be automated by a controller 76 (FIG. 22), graphical user interface, and/or remote control. A drive mechanism 66 can be operably connected to each liquid line 54 for oscillating or rotating each line through a radius of travel, as shown in FIG. 19. Liquid applicator 46 can be operated manually or automatically using one or more controllers 76 operated by a control system.

Liquid applicator 46 may be configured to clean seed bed 18 of debris, contaminants, mold, fungi, bacteria, and other foreign/unwanted materials. Liquid applicator 46 can also be used to irrigate seed 74 with a disinfectant, nutrients, or reactive oxygen species as seed is released onto seed bed 18 from a seed dispenser. A time delay can be used to allow the ROS or nutrients to remain on seed for a desired time before applying or irrigating with fresh water. The process of cleaning, descaling, and disinfecting seed bed 18 using liquid applicator 46D can be automated by a controller 76, graphical user interface, and/or remote control.

Liquid applicator 46 can be operated immediately after seeding of the seed bed 18 to saturate seed with liquid. Seed 74 in early, mid, and late stages of growth can be irrigated with liquid 62 using liquid applicator 46. Liquid applicators 46A-D can be operated simultaneously, intermittently, alternately, and independent of each other. During early stages of seed growth, both liquid applicators 46A-B are operated to best saturate seed to promote sprouting and germination. During later stages of growth, liquid applicator 46A can be used to irrigate more than liquid applicator 46B. Alternatively, liquid applicator 46B can be used to irrigate more than liquid applicator 46A, depending upon saturation level of seed growth. Liquid applicator 46C can be operated during seeding of seed bed 18 and movement of seed bed 18 in the second direction to spray seed dispensed atop seed bed 18 to saturate seed with liquid. The liquid provided to liquid applicators 46A-D could include additives such as disinfectants, reactive oxygen species, fertilizer, and/or nutrients. Nutrients, such as commonly known plant nutrients such as calcium and magnesium, can be added to liquid dispensed from liquid applicators 46A-D to promote growth of healthy plants and/or increase the presence of desired nutrients in harvested seed. Liquid applicators 46C-D can be used also to sanitize seed bed 18 before and/or after winding on or unwinding of the seed belt, the seed bed 18, or seed egress 68 of the seed belt.

Liquid distributors 46A-D and their various components, along with other components of the grower system 10, can be sanitized by including one or more disinfectants, such as reactive oxygen species used by each liquid distributor 50A-D. For example, liquid guide 48, liquid lines 54, liquid egress 52, drain trough 60, liquid collector 58, seed bed 18, liquid distributors 50A-C, and other components of the growing system may be sanitized. In another aspect, liquid applicators 46A-D can be used to clean and sanitize seed bed 18 before, between, or after seeding and harvesting. A separate liquid distributor or manifold can be configured to disinfect or sanitize any components of the growing system that carry liquid for irrigation and cutting or receive irrigation or cutting runoff from the one or more holding containers.

The liquid 62 may be constantly applied, or the applicator may apply the liquid 62 at a set time frame or at a quantifiable amount. For example, the liquid applicator 46A-D may apply the liquid 62 for a first time period such as 1 minute and then the liquid applicator may stop applying the liquid 62 for a second time period, such as 4 minutes, or 1 min of liquid application for every 5 minutes. The cycle may continue until the developmental phase or seed out phase terminates. In another example, the liquid 62 may be applied for 10 min every 2 hours. The liquid applicator 46 may provide a controlled, evenly distributed flow allowing the liquid 62 to reach a maximum number of seeds. Excess liquid 62 may be captured, recycled, and reused by the grower system 10. If the seed bed 18 has an egress or a slant, the slant may aid in the even distribution of the liquid as it egresses through the seed bed 18. In some aspects, the liquid applicator 46 may guide the distribution of the liquid to areas within the seed bed 18, a portion of the seeds 74, or a portion of the plants 74 that need more application. The liquid applicators 46 may also oscillate to cover the larger areas of the seed bed 18 or the entire length and width of the seed bed 18 or seed belt 28.

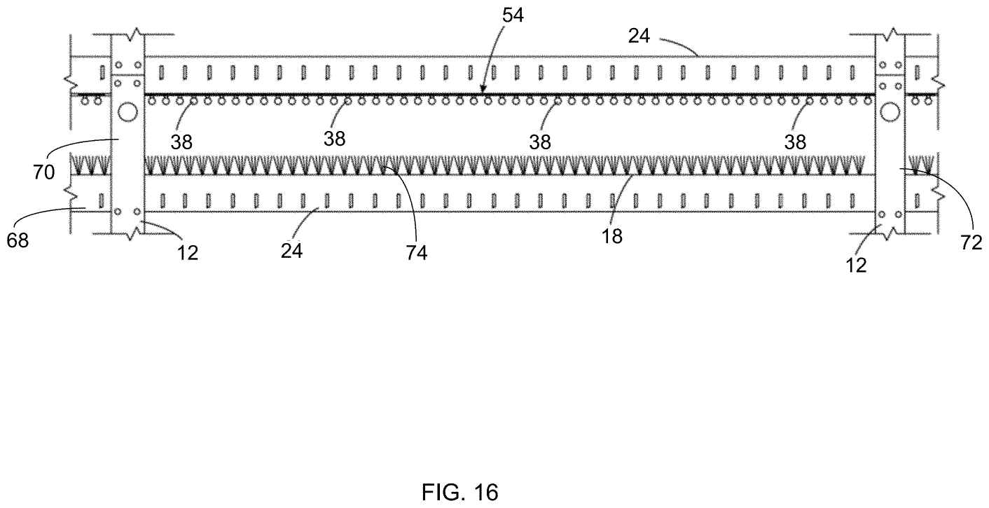

Each seed bed 18 may include one or more lighting elements 38 or housing lights for illuminating seed atop seed belt 28 to facilitate hydroponic growth of seed or a seed mass atop seed belt 28, as shown in FIG. 16. Lighting elements 38 may be operably positioned directly/indirectly above each seed bed 18. Lighting elements 38 can be turned off and on for each level using a controller 76. Lighting elements 38 can be powered by an electrochemical source or power storage device, electrical outlet, and/or solar power. In one aspect, lighting elements 38 may be powered with direct current power. Contemplated lighting elements 38 include, for example, halide, sodium, fluorescent, and LED strips/panels/ropes, but are not limited to those expressly provided herein. One or more reflectors (not shown) can be employed to redirect light from a remote source not disposed above each seed bed 18. Lighting elements 38 can be operably controlled by a controller 76, a timer, user interface or remotely. Operation of lighting elements 38 can be triggered by one or more operations of grower 10. For example, operation of a seed belt 28 can trigger operation of lighting elements 38. The process of lighting a seed bed 18 can be automated by controller 76, graphical user interface, and/or remote control. In one aspect, lighting elements 38 may be low heat emission, full ultraviolet (UV) spectrum, light emitting diodes that are cycled off and on with a controller 76, preferably on 18 hours and off 6 hours in a 24-hour period.

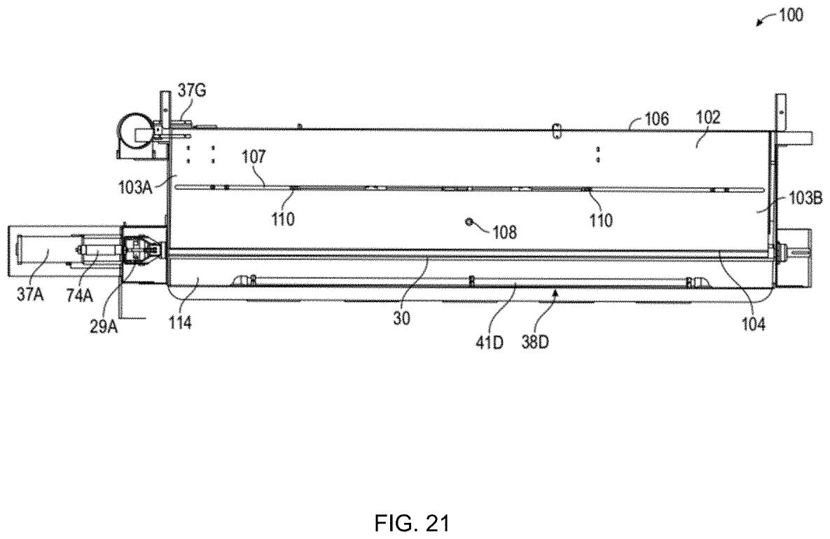

FIG. 21 illustrates the harvesting mechanism 100 in accordance with an illustrative aspect. Each seed bed 18 may include a harvesting mechanism 100. Harvesting mechanism 100 may include an offloading plate 102 operably attached to grower 10 adjacent roller 30 and extending across the width of seed bed 18 for harvesting grown plants that consist of sprouted seed, root mass, stem portion, and leaves. For purposes of the present disclosure, when referring to sprouted seed, root mass, stem portion, and leaves, the term “grown plants” is used. It is the grown plants that may be harvested from grower 10. Returning to offloading plate 102, the plate may be configured to include opposing outer edges 103A-B spaced between an inlet side 104 and discharge side 106. A discharge plate 102 may have generally the same width as seed belt 28. Inlet side 104 may face seed belt 28 and be disposed immediately adjacent roller 30 to receive offloaded grown plants. Discharge side 106 may face outward, extending away from roller 30 for offloading cut grown plants. At least one high pressure liquid nozzle 108 may be operably attached to a top side of offloading plate 102 and disposed generally in the middle across the width and between inlet side 104 and discharge side 106. Liquid nozzle 108 may be oriented to direct a high-pressure stream of liquid directly upward. One or more ports 107 may extend through offloading plate 102 across the width and between discharge side 106 and liquid nozzle 108. In one aspect, port 107 may be configured as a narrow channel, just wide enough for a stream of liquid to pass through, that extends generally across the width of offloading plate 102 and may be disposed between nozzle 108 and discharge side 106. Liquid nozzles 110 can be oriented to direct a high-pressure stream of liquid directly upward through port 107 in offloading plate 102. A drive mechanism 37G may be operably attached to the harvesting mechanism 100 to move the harvesting mechanism 100 between first and second positions. Drive mechanism 37G can be a high torque electrical motor that operates on AC or DC current, or a pneumatic/hydraulic motor or cylinder. In one aspect, the electrical motor can be an intermittent duty 12 VDC, 10+ amp motor. The drive mechanism 37G can be a motor, powered electrically, pneumatically, hydraulically, or even manually. In one aspect, drive mechanism 37G may be driven electrically with direct current power from a power source. One or more switches or sensors (not shown) can be operably configured to control drive mechanism 37G to control movement of the harvesting mechanism 100 in a first and second opposite direction between first and second positions. In one aspect, a first one of liquid nozzles 110 may be located nearly adjacent outer edge 103A and the second one of liquid nozzles 110 may be located generally at the middle of offloading plate 102. In the second position of harvesting mechanism 100, a first one of liquid nozzles 110 can be located generally at the middle of offloading plate 102 and the second one of liquid nozzles 110 can be located nearly adjacent outer edge 103B. During operation, liquid nozzles 110 may reciprocate back and forth between first and second positions of the harvesting mechanism 100 by actuation of drive mechanism 37G. The process of actuating drive mechanism 37G for moving harvesting mechanism 100 between first and second positions can be automated by controller 76 of the control system 82, graphical user interface, and/or remote control. In this manner and in operation, liquid nozzle 108 may cut through offloaded grown plants in a first direction and liquid nozzles 110 may cut through offloaded grown plants in a second direction opposite the first direction of liquid nozzle 108.

In one aspect, liquid nozzle 108 may cut longitudinally along the midpoint of offloaded grown plants and liquid nozzles 110 may cut transversely across the width of offloaded grown plants. In this manner, offloaded grown plants may be cut into portions smaller than the mass of grown plants on seed belt 28. The length of each cut piece of grown plants can be controlled by increasing or decreasing the speed of seed belt 28 or increasing or decreasing the reciprocating speed of harvesting mechanism 100. To increase the size of cut pieces of grown plants the speed of seed belt 28 or harvesting mechanism 100 can be reduced. Alternatively, to decrease the size of cut pieces of grown plants the speed of seed belt 28 or harvesting mechanism can be increased. The process of controlling drive mechanism 37A and 37G for controlling speed of seed belt 28 and harvesting mechanism 100 can be automated by controller 76, graphical user interface, and/or remote control. As discussed herein, harvesting mechanism 100 with liquid nozzles 110 may be operably secured to the underside of offloading plate 102 and shielded from being impacted from below by liquid from liquid nozzle 108 and liquid nozzles 110 using a cover plate 114.

The grower system 10 may have, such as shown in FIG. 22, a control system 76 for controlling different environmental conditions or operating conditions of the grower system. The control system 76 may control at least one air element 78 such as a fan or HVAC system to control air movement around the seed bed, as shown in FIG. 22. The air element 78 may be operably connected to the controller 76. A room or environment where the grower system 10 may be stored may also have one or more fans used to control air movement. The air movement or flow may be changed depending on the developmental phase of the seeds on the seed bed. A temperature element 80, such as an HVAC unit, may be operably connected to the grower system 10, controller 76, or the seed bed 18 to control the temperature of the environment of the seed bed 18. The temperature element 80 may maintain temperatures ranging of 65 to 85 degrees F. or 18 to 30 degrees C. A humidity element 82 may be operably connected to the controller 76, growing system 10, or seed bed 18 for controlling the humidity of the environment of the seed bed 18. The humidity unit 82 may maintain a relative humidity level between 50% and 90%. The temperature element 80, air element 78, and humidity element 82 may all include the same HVAC unit. The temperature and air humidity may be changed depending on the developmental phase of the seeds on the seed bed 18. The process of controlling the air movement, temperature, and humidity of a seed bed 18 can be automated by controller 76, graphical user interface, and/or remote control. The lighting, temperature, air flow, and liquid application may all affect the humidity of the seed bed 18.

Once the plant or seed has reached maturity or a point of maximum enzyme activity the seed or plant may be removed from the seed belt 18. The plant may be moved to a mixer where the plant can be mixed to form animal feed. Prior to reaching the mixer, the plant may be cut or chopped to an appropriate feed size. The plant may be mixed with other hydroponically grown plants or plants grown by other methods such as in a field, nursery, or garden. If additional plant matter may need to be added to the plant grown on the grower system, the additional plant matter may be added at a certain ratio, such as, for example only, 2/3 of the mixture includes the plant grown on the grower system and 1/3 of the mixture is the additional plant matter. In some aspects of the present disclosure, the ratio may be 1:1 or 45 percent hydroponically grown cellulosic material utilizing the grower system and 55 percent other plant or cellulosic material. In other aspects of the present disclosure, the mixing may occur after the ensiling process is complete. In some aspects the ensiled animal product contains between 45% to 60% dry matter or dry matter inclusion. In some aspects of the present disclosure, the percentage of dry matter may be lower. The hydroponically grown animal feed, cellulosic material, or plant may be wet when harvested a limited aerobic phase is needed or the aerobic phase is eliminated all together. The enisling process considers the moisture content of the animal feed, the preservatives or innoculants used in the ensiling process, the dry matter content and the mixture ratio. In some aspects, if the hydroponically grown material has a high moisture content the mixture ratio may be greater or the amount of dry matter needed may be greater.

The inoculants may include lactic acid bacteria (LAB). In some aspects, the ensiling process may only use homofermentative strains or heterofermentative strains while in other aspects of the present invention use a combination of both types of LAB. The homofermentative bacteria may include Lactobacillus plantarum, Pediococcus, Enterococcus and Lactococcus to enhance the production of lactic acid, which lead to a faster drop in pH value, a limited aerobic phase, and improved fermentation, thus reducing dry matter losses, harmful protein breakdown and growth of undesirable microorganisms. The heterofermentative bacteria may include Lactobacillus brevis, L. kefiri and L. buchneri to convert forage sugars to lactic and acetic acid, reducing the duration of the aerobic phase. The production of acetic acid will improve aerobic stability of the silage by preventing proliferation of undesirable yeast and mold keeping silage highly nutrient and hygienic. The preservatives may include organic acids such as propionic and formic acids. The organic acids may lower the silage pH to make it less favorable for undesirable bacteria such as Clostridia and reduce the aerobic phase allowing cool fermentation to occur. Other organic acids and their salts including potassium sorbate and sodium benzoate target the growth of yeasts and mold fungi either in fermentation or during feed out. The inoculants and preservatives help prevent the animal feed from spoiling if oxygen is introduced to the animal feed or cellulosic material after the aerobic phase has finished.

After the animal feed is mixed, harvested or cut, the ensiling process may begin utilizing an ensiling apparatus 84. The feed may be sealed in an oxygen free environment 86, such as a silo or a sealed bag. The animal feed may also be loaded into a sealed bag after the ensiling process is complete. The ensiling process may limit the amount of alcohol present in the animal feed or cellulosic material. The ensiling process may remove oxygen from the seal environment during the beginning of the ensiling process. For example, oxygen may be removed by a vacuum seal or by any other method sufficient to remove oxygen from a bag, silo, or other storage container.

During the ensiling process, the plant or animal feed may be placed in an anaerobic environment. Phase one, plant respiration, begins shortly after the plant is cut. Plant cells are still living and enzyme activity is still maximized. The enzymes continue to break down cellulosic material and carbohydrates reducing the amount of carbohydrates, thereby, resulting in a higher quality feed that is less likely to spoil. However, wet animal feed or cellulosic material utilizes cool fermentation during the ensiling process by limiting the aerobic phase. The sugar and remaining oxygen react to form carbon dioxide and water while aerobic bacteria produce heat. The degradation of plant proteins to nonprotein nitrogen (NPN), peptides, amino acids, and ammonia by plant cell proteases decreases the pH. Once the pH of the animal feed drops to a certain level and the oxygen supply decreases past a certain amount, phase two, acetic acid production, begins. By maximizing enzyme activity in the plants grown on the grow system, more plant carbohydrates are broken down thereby providing conditions for an efficient ensiling process. In some aspects of the present disclosure, by maximizing enzyme activity during harvest, the duration of the aerobic phase or phase one may be decreased or eliminated, limiting the amount of ammonia nitrogen associated with lower dry matter intake. The preservation of sugar is crucial to the preservation of the animal feed during the storage phase. Loss of sugars due to fermentation by LAB lowers the pH to ensure greater storage. Without elevated sugars, LAB cannot produce enough acetate or other acids to lower pH to acceptable levels. Increasing the availability of the carbohydrates expedites the process and lowers pH of the ensiled product.

During phase two of the ensiling process, the anaerobic fermentation phase, anaerobic bacteria begin to grow due to the lack of oxygen and the breakdown of protein by plant cells slows. Different populations of anaerobic bacteria ferment the sugars converting the sugars to primarily lactic acid or acetic acid, ethanol or carbon dioxide. The production of lactic acid continues to lower the pH of the animal feed, inhibiting the growth of certain microbes.

During phase three, the animal feed may stored. The pH of the animal feed remains relatively stable during the storage phase. The enzyme and microbes activity are minimal, thereby increasing shelf life of the animal feed. The animal feed may be placed in a silo or in a sealed bag preventing oxygen from entering. If oxygen is allowed to enter the storage container, yeast and mold may grow decreasing dry matter and potentially spoiling the animal feed.

Phase four may include the feed out stage. During phase four, the animal feed may be exposed to oxygen and feed to the animals. Once the animal feed is re-exposed to oxygen, yeast and mold activity may start up or increases converting residual sugars, fermentation acids and other soluble nutrients into carbon dioxide, water and heat.

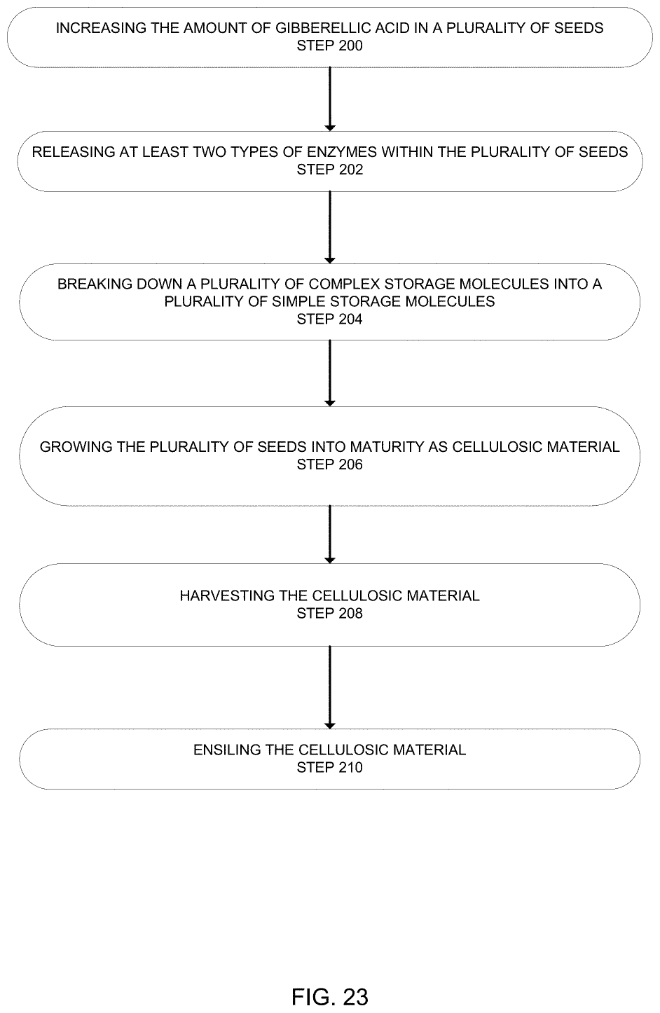

In one aspect of the present disclosure a method for ensiling hydroponically grown cellulosic material is disclosed and shown in FIG. 23. The method may include increasing the amount of gibberellic acid of a plurality of seeds on a seed bed of a grower system (Step 200). The grower system may be configured to control a plurality of environmental factors utilizing a controller. Next, at least two types of enzymes within the plurality of seeds may be released (Step 202). The at least two types of the enzymes may be released by the increase in the amount of gibberellic acid within the plurality of seeds. Next, a plurality of complex storage molecules may be broken down into a plurality of simple molecules by at least one of the types of enzymes (Step 204). Next, the at least one seed can be grown to maturity as cellulosic material (Step 206). The enzyme activity of the cellulosic material may be maximized by the breakdown of the plurality of complex storage molecules. Next, cellulosic material can be harvested from the seed bed (Step 208). Next, the cellulosic material may be ensiled (Step 210). The enzyme activity may increase the protein breakdown during the aerobic phase of the ensiling. Prior to the ensiling or after the ensiling, the cellulosic material may be mixed with a second cellulosic material. The mixing or blending of the two cellulosic materials may occur at a specific ration. Once the ensiling process is finished, the cellulosic material may be sealed in a storage container.

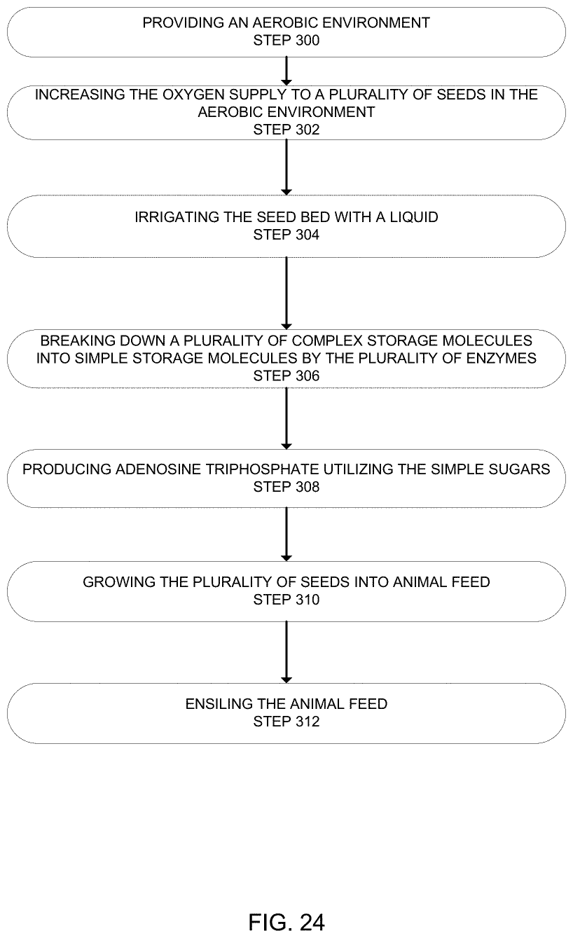

In another aspect of the present disclosure, a method for ensiling hydroponically grown animal feed is disclosed as shown in FIG. 24. The method may include providing an aerobic environment utilizing a grower system configured to control a plurality of environmental factors (Step 300). Next, the oxygen supply to the plurality of seeds may be increased (Step 302). The increase may occur from the expansion of the plurality of seeds onto a seed egress of the grower system. Next, the seeds may be irrigated with a liquid (Step 304). The liquid may include water, fertilizer, ROS, or any other liquid that is beneficial to growing plants. The liquid or the increase in oxygen may increase an amount of gibberellic acid in the plurality of seeds. The increase in gibberellic acid releases at least two types of enzymes within the plurality of seeds. Next, a plurality of complex storage molecules may be broken into a plurality of simple sugar molecules by hydrolysis (Step 306). Next, ATP may be produced utilizing the plurality of simple sugars (Step 308). Next, the seed can be grown into animal feed (Step 310). The protein breakdown within the animal feed can be increased by the production of ATP. Lastly the animal feed may be ensiled (Step 312). During the ensiling process, the animal feed may be stored in an oxygen free environment.

The disclosure is not to be limited to the particular aspects described herein. In particular, the disclosure contemplates numerous variations in ensiling hydroponically grown animal feed. The foregoing description has been presented for purposes of illustration and description. It is not intended to be an exhaustive list or limit any of the disclosure to the precise forms disclosed. It is contemplated that other alternatives or exemplary aspects are considered included in the invention. The description is merely examples of aspects, processes, or methods of the disclosure. It is understood that any other modifications, substitutions, and/or additions can be made, which are within the intended spirit and scope of the disclosure.

What is claimed is:

1. A method for ensiling hydroponically grown cellulosic material, the method comprising:
increasing the amount of gibberellic acid of a plurality of seeds on a seed bed of a grower system, wherein the grower system is configured to control a plurality of environmental factors;
releasing at least two types of enzymes within at least one seed of the plurality of seeds, wherein the at least two types of the enzymes are released by the increase in the amount of gibberellic acid;
breaking down a plurality of complex storage molecules into a plurality of simple molecules within the at least one seed by at least one enzyme of the at least two enzymes;
growing the at least one seed to maturity as cellulosic material, wherein enzyme activity of the animal feed is maximized by the breakdown of the plurality of complex storage molecules;
harvesting the plurality of seeds from the seed bed;
ensiling the cellulosic material; wherein the enzyme activity decreases protein breakdown during ensiling.

2. The method of claim 1, wherein the complex storage molecules comprise cellulose and wherein the plurality of simple molecules comprise hemicellulose.

3. The method of claim 1, wherein the plurality of simple molecules comprises simple sugars and wherein the simple sugars are utilized as an energy source by lactic acid bacteria during the ensiling step.

4. The method of claim 1, wherein a duration of the aerobic phase is shortened by the maximizing enzyme activity.

5. The method of claim 1, wherein at least one of the at least two types of enzymes break down carbohydrates elevating simple sugar levels in the cellulosic material.

6. The method of claim 1, wherein the at least one enzyme of the at least two enzymes comprises proteases.

7. The method of claim 1, wherein the at least one enzyme increases dry matter of the cellulosic material.

8. A method for ensiling hydroponically grown animal feed, the method comprising:
providing an aerobic environment utilizing a grower system configured to control a plurality of environmental factors;
increasing oxygen supply to the plurality of seeds;
irrigating the plurality of seeds with a liquid;
breaking down a plurality of complex storage molecules into a plurality of simple molecules within the plurality of seeds by hydrolysis;
producing adenosine triphosphate utilizing the plurality of simple sugars;
growing the at least one seed into animal feed, wherein protein breakdown of the animal feed is increased by the production of adenosine triphosphate; and
ensiling the animal feed.

9. The method of claim 8, wherein the liquid comprises at least one reactive oxygen species and wherein the at least one reactive oxygen species increases enzyme activity.

10. The method of claim 8, wherein the plurality of complex storage molecules comprise carbohydrates and wherein the simple storage molecules comprise simple sugars and wherein the simple sugars provide energy to lactic acid bacteria during the ensiling step.

11. The method of claim 10, wherein the aerobic environment increases gibberellic acid and wherein the gibberellic acid increases the breakdown of the plurality of complex storage molecules.

12. The method of claim 8, further comprising:
releasing at least two types of enzymes within at least one seed of the plurality of seeds, wherein the at least two types of the enzymes are released by the increase in the amount of gibberellic acid.

13. The method of claim 8, wherein lactic acid bacteria utilize simple molecules during the ensiling step as an energy source.

14. The method of claim 8, wherein the breakdown of complex storage molecules decreases dry matter shrinkage during the ensiling step.

15. An ensiling system for ensiling hydroponically grown animal feed, the system comprising:
a grower system further comprising:
a seed bed operably supported by a framework and disposed across a length and width of the framework having a first side opposing a second side and a first terminal end opposing a second terminal end, wherein the seed bed is configured to house a plurality of seeds and grow the seeds into maturity as animal feed;
a control system for controlling a plurality of environmental factors of the seed bed, wherein the plurality of environmental factors provide an aerobic environment for growing the plurality of seeds, wherein the plurality of environmental factors comprise oxygen and water;
wherein the aerobic environment increases gibberellic activity within the plurality of seeds;
wherein at least two types of enzymes within at least one seed of the plurality of seeds are released, wherein the at least two types of the enzymes are released by the increase in the amount of gibberellic acid;
wherein a plurality of complex storage molecules are broken down into a plurality of simple molecules within the at least one seed by at least one enzyme of the at least two enzymes;
a harvesting mechanism for removing the animal feed from the seed bed; and
an ensiling apparatus for fermenting the plant and storing the plant, wherein lactic acid bacteria utilize the plurality of simple molecules during fermentation.

16. The ensiling system of claim 15, wherein the breakdown of complex storage molecules decreases dry matter shrinkage during fermentation.

17. The ensiling system of claim 15, wherein the plurality of environmental factors further comprises temperature and light.

18. The ensiling system of claim 15, wherein the plurality of complex storage molecules comprise carbohydrates and wherein the simple storage molecules comprise simple sugars and wherein the simple sugars provide energy to lactic acid bacteria during fermentation.

19. The ensiling system of claim 15, wherein the complex storage molecules comprise cellulose and wherein the plurality of simple molecules comprise hemicellulose.

20. The ensiling system of claim 15, wherein the increase in enzyme activity increases a duration of a storage phase during fermentation.
